(19) United States
(12) Patent Application Publication
(10) Pub. No.: US 2024/0210695 A1
(43) Pub. Date: Jun. 27, 2024

(54) Display Engines and Systems Using Photonic Integrated Circuit Chips with Integrated Actuators

(71) Applicant: Max-Planck-Gesellschaft zur Foerderung der Wissenschaften e.V., Munich (DE)

(72) Inventors: Wesley Sacher, Halle (DE); Joyce Poon, Halle (DE)

(73) Assignee: Max-Planck-Gesellschaft zur Foerderung der Wissenschaften e.V., Munich (DE)

(21) Appl. No.: 18/394,132

(22) Filed: Dec. 22, 2023

Related U.S. Application Data
(60) Provisional application No. 63/476,803, filed on Dec. 22, 2022.

(51) Int. Cl. G02B 27/01

(52) U.S. Cl. CPC G02B 27/0172; G02B 2027/0112

(57) ABSTRACT

A display engine for a laser-scanning head-mounted display uses one or more photonic integrated circuit chips to generate multiple intensity-modulated laser beams. These beams are scanned across the field of view with an off-chip scanning mirror, one or more actuators integrated with the chip, or a combination of an off-chip scanning mirror and integrated actuators. The actuators move output couplers (e.g., waveguide emitters with waveguide edge couplers at the ends) that emit light from the photonic chip, forming multiple independent optical beams. Movement of the actuator translates the beams such that each of the beams addresses a portion of the field of view of a displayed image. An optical combiner and relay optics expands these beams and directs them toward the eye of the person wearing the display.

### CROSS-REFERENCE TO RELATED APPLICATION(S)

This application claims the priority benefit, under 35 U.S.C. 119(e), of U.S. Application No. 63/476,803, which was filed on Dec. 22, 2022, and is incorporated herein by reference in its entirety for all purposes.

### BACKGROUND

Head-mounted displays and near-eye displays for mixed reality (also referred to as augmented reality or extended reality) are transparent glasses that overlay images generated by light engines onto the user's field of view. The light engines are typically on the periphery of the glasses and the light is guided and directed toward the user's eyes using optical combiners. The optical components/systems should be small enough and light enough to fit comfortably on a head-mounted display.

FIG. 1A shows a conventional light engine 100 and waveguide combiner 110 (here, an optical combiner based on total internal reflection) for a near-eye display for one eye 10. (Binocular headsets use two of these near-eye displays). The waveguide combiner 110 is a thin (e.g., about 1 mm thick) piece of glass or plastic with an input coupler 112, pupil replication elements 114, and an output coupler 116. Light from the light engine 100 is coupled into the waveguide combiner 110 via relay optics 120 and the input coupler 112, guided by total internal reflection (TIR) at the interfaces of the waveguide combiner 110, replicated by the pupil replication elements 114, and further replicated and out-coupled toward the eye 10 by the output coupler 116. The input coupler 112, pupil replication elements 114, and output coupler 116 are typically diffractive optical elements (e.g., surface relief gratings) defined on the surface of the waveguide combiner 110. Overall, collimated beams input to the waveguide combiner 110 are expanded and output toward the eye 10 forming an image focused at infinity, whereby collimated beams with horizontal and vertical angles (θ, φ) are focused to a position (x, y) on the user's retina. Since the images are focused at infinity, the display system is typically characterized by an angular field of view (FOV).

FIG. 1B illustrates a conventional laser-scanning head-mounted display 198. Laser-scanning light engines have become the focus of a growing number of commercial efforts for head-mounted displays. Laser scanning has advantages of increased brightness and image contrast compared to panel microdisplays.

In the laser-scanning head-mounted display 198 in FIG. 1B, laser diodes 102 emit red, green, and blue laser beams that are collimated, aligned, and combined using free space optics, such as collimation optics and dichroic filters. The laser beams reflect off a scanning mirror system 104 (e.g., one or two micro-electro-mechanical systems (MEMS) mirrors) and are coupled into the input coupler 112 of the waveguide combiner 110 via relay optics 120. The scanning mirror system 104 scans the collimated beam in two angular directions (θ, φ); a fast axis of the mirror 104 scans lines of the FOV at the fast-axis mirror scan frequency, and a slow axis sweeps the line across the FOV.

The collimated beam is expanded and relayed to the viewer, and the FOV addressing approach is shown in FIG. 1C. The fast axis of the mirror 104 is typically operated in resonant mode (e.g., at a scan rate of >10 kHz) and the slow axis is scanned linearly (e.g., at a 60 Hz scan rate). Meanwhile, the lasers 102 are directly modulated (modulated in intensity) at rates >100 MHz to define the intensity of each point in the image. Overall, the laser beams are periodically scanned over the FOV (while modulated in intensity) fast enough that static images and video (with no flicker) can be observed by the viewer.

The laser-scanning approach has multiple performance tradeoffs and limitations. First, for a fixed fast-axis mirror scan frequency and maximum laser modulation rate, there is a tradeoff between FOV and resolution. That is, for each displayed frame, there is a maximum number of resolvable spots that can be defined due to the limited mirror and laser modulation speeds.

Second, there are practical limitations on the fast-axis mirror scan frequency. Increasing the fast-axis mirror scan frequency usually requires reducing the mirror size, and hence, reducing the beam size. This increases the divergence of the beam and compromises the operation of the optical combiner 110—both degrading the spatial resolution. Beam diameters >2 mm are typically used for fine spatial resolution. Mirror scan frequencies of about 25-50 kHz are the current state of the art.

Third, there are also practical limitations on laser modulation rates. Practical modulation rates are about 250-500 MHz. Higher-speed operation could involve complex drive electronics (including high-speed digital to analog converters). In addition, modulation rates >1 GHz may be limited by the relaxation resonance frequency of the lasers.

Fourth, the laser-scanning head-mounted display 198 is complex, requires a complicated packaging procedure, and is difficult to miniaturize. It includes many free-space optical components that must be aligned and packaged together.

As an example of the limitations of the laser-scanning display approach, achieving a 4 k resolution (3840 pixels×2160 pixels) with a wide FOV of 640×36° (73.4° diagonal; state-of-the-art FOVs are −50° diagonal) at a 120 Hz frame rate requires a fast-axis mirror scan frequency of about 130-230 kHz (depending on the orientation of the fast axis and the FOV) and a laser modulation rate of 1 GHz (i.e., 1 ns per pixel). The mirror scan frequency is too fast for mirrors with diameters >1 mm, and the laser modulation rate would be challenging to achieve due to the requirements of complex electronics and the size limitations of head-mounted displays.

### SUMMARY

Photonic integrated circuits for visible light are an emerging technology for achieving complex visible-spectrum functionalities in extremely small (chip-scale) form factors. Such circuits typically include silicon nitride (SiN), silicon oxynitride (SiON), aluminum oxide (Al₂O₃), polymer, or doped glass waveguides with silica (SiO₂) cladding—all made on silicon (Si) or silicon-on-insulator (SOI) wafers, enabling mass production. The display systems described herein use visible-light photonic integrated circuits to overcome limitations of other laser-scanning, head-mounted displays.

An inventive laser-scanning, head-mounted display system may include a photonic integrated circuit chip to generate multiple intensity-modulated laser beams, one or more scanning mirrors (e.g., a two-axis MEMS mirror or cascaded single-axis MEMS mirrors that tilt along different axes) to scan the laser beams along two axes, and an optical combiner wherein the laser beams are coupled, expanded and/or replicated, and output toward the eye of the person wearing the display.

Multiple photonic integrated circuit chips, each with one or more integrated two-axis actuators, can be stacked together or otherwise combined to make a display engine for an inventive laser-scanning, head-mounted display system. The actuators may have waveguide emitters (e.g., waveguide edge couplers at the end) that emit light from the chip, forming multiple independent optical beams. Movement of the actuator translates the beams, and each beam addresses a portion of the field of view of a displayed image. The photonic integrated circuit chips can be combined with an optical combiner and relay optics to form an inventive laser-scanning, head-mounted display system.

Another inventive laser-scanning, head-mounted display system may include a photonic integrated circuit chip with waveguides configured to guide light from a set of light sources to a set of light-emitting waveguides, grating couplers, or edge couplers. Suitable light sources include lasers that are optically coupled to and mechanically packaged together with the photonic integrated circuit chip. The display system may also include a scanning mirror system that scans light along two axes to form an image with a corresponding field of view (FOV). Optical elements relay light from the photonic integrated circuit chip to the scanning mirror system and relay light from the scanning mirror system to an optical combiner, which guides the light from an input coupler to an output coupler through which an image can be viewed. The optical combiner can be a waveguide combiner with diffractive optical elements for the input coupler, output coupler, and pupil replication/expansion. The optical combiner may also include partial reflectors for pupil expansion/replication and output coupling.

The optical elements that relay light from the emitting waveguide devices to the scanning mirror system can reduce the divergence of or collimate the beams emitted by the waveguide, grating, or edge couplers. The waveguides, grating couplers, or edge couplers are positioned on the photonic integrated circuit chip such that they emit beams on the scanning mirror system at different angles. The waveguides, gratings, or edge couplers can be on a curved facet and/or multiple facets of the photonic integrated circuit chip. The photonic integrated circuit chips can also be stacked to form a two-dimensional (2D) array of waveguides, gratings, or edge couplers.

An inventive laser-scanning, head-mounted display system can display an image as follows. Optical waveguides guide beams from a set of lasers to output couplers at various points on a photonic integrated circuit chip. The output couplers emit the beams into free space, where free-space optical elements, such as lenses or diffractive optical elements, collimate or reducing the divergence of the beams. A scanning mirror system directs the beams, which are incident on the scanning mirror system at different angles, along different slices of the FOV in parallel. The scanning mirror system steers or scans the beams along a first axis at a higher frequency and along a second axis at a lower frequency. Each beam addresses a rectangular or curved strip of the FOV that overlaps with the adjacent strips, addressing the FOV in parallel. The laser power may be modified in the regions where strips overlap (for brightness uniformity), and these regions of overlap may be interlaced. An input coupler couples the beams reflected by the scanning mirror system to an optical combiner, which guides the beams and outputs them so that they can be viewed by a person wearing the head-mounted display system. Additional free-space optical elements may be used to relay the beams reflected by the scanning mirror system to the input coupler.

A head-mounted display may include a photonic integrated circuit chip, lasers and optical waveguides coupled to the photonic integrated circuit chip in optical communication with each other, edge couplers extending from a facet of the photonic integrated circuit chip in optical communication with the optical waveguides, and an actuator. In operation, the lasers emit beams of light (e.g., at red, green, and blue wavelengths) that are guided by the optical waveguides to the edge couplers, which emit the beams of light into free space. The actuator moves the edge couplers in a first direction so as to scan the beams of light across respective slices of a field of view of the head-mounted display. The head-mounted display may also include another (i.e., a second) actuator that can move the edge couplers in a second direction different than the first direction so as to scan the beams of light across the field of view.

The lasers can emit the beams of light as amplitude-modulated beams of light in response to electrical modulation. The photonic integrated circuit chip can also include switches optically coupled to the optical waveguides and configured to route the beams of light among the optical waveguides.

Each of the edge couplers may include a dielectric cantilever extending from the facet of the photonic integrated circuit chip, a waveguide core formed in the dielectric cantilever, and a metal layer disposed on at least one side of the dielectric cantilever. The actuator can comprise an electrode configured to apply an electrostatic force to the metal layer and/or a heater configured to heat the metal layer. The actuator may move the edge couplers in the first direction over a distance equal to or greater than a pitch of the edge couplers in the first direction.

The head-mounted display can also include relay optics and an optical combiner. The relay optics are in optical communication with the edge couplers and collimate the light emitted by the edge couplers. And the optical combiner is optically coupled to the relay optics and guides the light emitted by the edge couplers to an eye of a person wearing the head-mounted display. Optionally, the head-mounted display can include a third actuator configured to vary a distance between the edge couplers and the relay optics.

All combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A illustrates a conventional head-mounted display based on a light engine and waveguide combiner. The waveguide combiner relays light by total internal reflection (TIR), and the couplers and pupil replication element are typically diffractive optical elements. Multiple reflections off the surface with the pupil replication and output coupler diffractive elements result in replication of the input pupil for an expanded output beam formed from many closely spaced copies of the input pupil.

FIG. 1B illustrates a conventional laser-scanning head-mounted display. The outputs of discrete red (R), green (G), and blue (B) lasers are combined into one beam using free-space optics, scanned using a scanning mirror system (e.g., a MEMS mirror), and relayed to the input coupler of the optical combiner. The collimated beams emitted from the output coupler at different angles (0, p) form an image focused at infinity with an angular field of view (FOV).

FIG. 1C illustrates the FOV observed by the viewer using the addressing method of the laser-scanning approach shown in FIG. 1B. The scanning mirror system periodically scans the laser beam over the FOV while direct modulation of the lasers sets the intensity of each pixel.

FIGS. 2A and 2B show top and side views, respectively, of an inventive display engine with photonic integrated circuits. The portion of the display engine shown in FIG. 2A includes a photonic integrated circuit with red (R), green (G), and blue (B) flip-chip bonded lasers. Each laser is coupled to a waveguide on the photonic circuit chip, and an example cross-section of a silicon nitride (SiN) waveguide is shown. Each waveguide is routed to a facet of the chip, potentially crossing other waveguides, and terminates at the facet with an edge coupler, which emits light from the facet. The light from each edge coupler diverges until reaching optics that collimate and redirect the beam to a scanning MEMS mirror. The scanning MEMS mirror scans the beams along two axes, and (top right) the beams are coupled into an optical combiner or waveguide combiner via relay optics. The optical combiner expands the beams and relays them to the eye. (Bottom right) This approach results in the FOV of the viewer being scanned by the multiple beams from the photonic integrated circuit chip, and each beam is responsible for a slice of the FOV addressing the FOV in parallel. The lasers are intensity-modulated to define the intensity of each pixel in the image.

FIG. 3A shows a display engine with wavelength multiplexer devices on the photonic integrated circuit chip to multiplex onto each edge coupler waveguide a red, green, and blue signal; each edge coupler then emits an RGB beam with R, G, and B light propagating coaxially.

FIG. 3B a display engine with M lasers per color and N edge couplers per color, where M<N. Optical switch devices on the photonic circuit chip route the light from the lasers to the edge couplers. As an example, the optical switches may be formed from cascaded Mach-Zehnder interferometer (MZI) switch devices. Thermo-optic switches could be used for speeds up to about 10 kHz. MEMS switches could be used for speeds up to about 1 MHz. Electro-optic switches (e.g., lithium niobate or barium titanate) can operate at speeds of about 1 MHz to more than 1 GHz. Electro-optic materials may be integrated onto the photonic integrated circuit chip, e.g., through hybrid integration (bonding the material onto the chip) or packaging a separate chip with the electro-optic material together with the photonic integrated circuit chip.

FIG. 3C shows top-down and side views of the photonic integrated circuit chip of FIG. 3B together with a waveguide combiner.

FIG. 3D shows an example multiplexing scheme for the photonic integrated circuit chip of FIGS. 3B and 3C.

FIG. 3E shows example parameters for the multiplexing scheme of FIG. 3D.

FIG. 3F shows an example line-switching multiplexing scheme for the photonic integrated circuit chip of FIGS. 3B and 3C.

FIG. 3G shows example parameters for the multiplexing scheme of FIG. 3F.

FIG. 4 shows a display engine with high-speed optical modulators on the photonic integrated circuit chip that apply intensity modulation (instead of direct modulation of the lasers). Here, light from each laser is split into multiple waveguides using on-chip splitter devices; each of these waveguides connects to an on-chip optical intensity modulator followed by routing waveguides connected to edge couplers for emitting the light. As an example, the optical modulators may be Mach-Zehnder interferometer (MZI) modulators using high-speed phase shifters.

FIG. 5A shows how axial offsets between edge couplers for R, G, and B beams in a display engine can be used to achieve specific beam properties for each color, possibly correcting for chromatic aberrations in the collimation/relay optics.

FIG. 5B shows a photonic integrated circuit chip with a curved emitting facet. The shape of the emitting facet is an additional degree of freedom for the design, which may be beneficial for the design of the collimation/relay optics.

FIG. 5C shows edge couplers on multiple facets of a photonic circuit chip.

FIG. 5D shows a top-down view of a photonic integrated circuit chip with a curved chip facet and integrated optical switches.

FIG. 5E shows a top-down view of a photonic integrated circuit chip with integrated intensity modulators and optical switches.

FIG. 6 shows additional edge coupler details, including inverse taper edge couplers (upper right) and bi-layer edge couplers (lower right).

FIG. 7 shows a display engine with stacked photonic integrated circuit chips. This creates a 2D array of edge couplers and enables FOV splitting along two axes.

FIG. 8A shows a display engine with edge coupler positions chosen such that subsets of edge couplers on a small pitch enable an interlaced scan pattern within each slice of the FOV (in this example, two edge couplers per FOV slice are shown, but there may be more edge couplers per FOV slice).

FIG. 8B shows the multiplexed beams emitted by the edge couplers of FIG. 8A and as seen by the viewer.

FIG. 9 shows a display engine with grating couplers instead of edge couplers. The grating couplers emit light vertically from the chip or at an angle relative to the normal of the chip. Multiple rows of grating couplers can be defined in the photonic integrated circuit, enabling splitting of the FOV along two axes.

FIG. 10A shows a top-down view of a photonic integrated circuit chip with edge couplers moved with integrated actuators. The actuators are drawn as cantilevers but can be considered general two-axis actuators for the invention.

FIG. 10B shows how light from the edge couplers in photonic integrated circuit chip(s) of FIG. 10A is coupled to an optical combiner (e.g., a waveguide combiner) via relay optics (e.g., lenses) and subsequently coupled out toward the eye by the optical combiner.

FIG. 10C illustrates multiplexing with multiple beams emitted by the photonic integrated circuit chip(s) of FIG. 10A addressing different slices of the FOV observed by the viewer.

FIG. 10D shows an example multiplexing scheme for the photonic integrated circuit chip of FIGS. 10A-10C.

FIG. 10E shows example parameters for the multiplexing scheme of FIG. 10D.

FIG. 10F shows an example line-switching multiplexing scheme for the photonic integrated circuit chip of FIGS. 10A-10C.

FIG. 10G shows example parameters for the multiplexing scheme of FIG. 10F.

FIG. 11 illustrates a photonic integrated circuit chip with integrated thermal and electrostatic actuators. Thermal actuation on the vertical axis is due to heating by a resistive heater (and differing thermal expansion coefficients of SiO₂ and the metal layers) in the cantilevers. Electrostatic actuation is used on the horizontal axis.

FIG. 12A illustrates a photonic integrated circuit chip with cascaded thermal actuators for a large vertical translation and thermal actuators on individual cantilevers for horizontal translation.

FIG. 12B illustrates a photonic integrated circuit chip with a first set of cascaded thermal actuators for a large vertical translation and a second set of cascaded thermal actuators for large horizontal translation.

FIG. 13 illustrates a photonic integrated circuit chip with cascaded thermal actuators for a large vertical translation and electrostatics comb drives for horizontal translation of the edge coupler array.

FIG. 14A illustrates electrostatic comb drives used for both vertical and horizontal actuation of edge couplers in a photonic integrated circuit chip.

FIG. 14B illustrates electrostatic comb drives used for vertical actuation and thermal actuators used for horizontal translation of the edge couplers.

FIG. 15 illustrates a photonic integrated circuit chip with multiple edge coupler arrays, each with actuators and coupled to separate input couplers of a waveguide combiner (via relay optics).

FIG. 16A shows top-down and side views of a photonic integrated circuit chip with on-chip actuators and a separate MEMS mirror.

FIG. 16B shows an example multiplexing scheme for the photonic integrated circuit chip of FIG. 16A.

FIG. 16C shows example parameters for the multiplexing scheme of FIG. 16B.

FIG. 17A shows a top-down view of a photonic integrated circuit chip with off-chip actuators.

FIG. 17B shows a cross-section of movable cantilevers with embedded waveguides suitable for use in the photonic integrated circuit chip of FIG. 17A.

FIG. 18A shows a top-down view of a photonic integrated circuit chip with piezoelectric actuators.

FIG. 18B shows a cross-section of movable cantilevers with embedded waveguides and piezoelectric actuators suitable for use in the photonic integrated circuit chip of FIG. 18A.

FIG. 19A shows a top-down view of a photonic integrated circuit chip with vertical emitters on a movable plate.

FIG. 19B shows a side view of the photonic integrated circuit chip of FIG. 19A (top) with an example multiplexing scheme (bottom).

FIG. 20A shows a top-down view of a photonic integrated circuit chip with a separate actuator chip.

FIG. 20B shows a side view of the photonic integrated circuit chip of FIG. 20A (top) with a close-up of one of the springs connecting the movable plate to the photonic integrated circuit chip.

FIG. 21 shows a top-down view of a photonic integrated circuit chip with an inner frame and a movable plate.

FIG. 22A shows top-down and side views of a photonic integrated circuit chip that is electromagnetically actuated in an inner frame.

FIG. 22B shows a top-down view of a photonic integrated circuit chip with external piezoelectric actuators.

FIG. 23A shows top-down and side views of a photonic integrated circuit chip with grating couplers on suspended cantilevers for vertical emission.

FIG. 23B shows a cross-section of an alternative vertical emitter suitable for use in a photonic integrated circuit chip.

FIG. 24A shows a top-down view of laser chips aligned to edge couplers on a photonic integrated circuit chip.

FIG. 24B shows a top-down view of lenses optically coupling laser chips to edge couplers on a photonic integrated circuit chip.

FIG. 24C shows a top-down view of laser array chips aligned to waveguides on a photonic integrated circuit chip, with a cross-sectional view of a laser chip at lower right.

FIG. 25A shows a top-down view of a photonic integrated circuit chip with edge couplers on an electromagnetically actuated tilt plate.

FIG. 25B shows a top-down view of a photonic integrated circuit chip with edge couplers on a piezoelectrically actuated tilt plate.

FIG. 26 shows top-down and side views of a movable photonic integrated circuit chip with vertical waveguide emitters.

FIG. 27 shows top-down and side views of stacked photonic integrated circuit chip with edge couplers attached to a separate actuator.

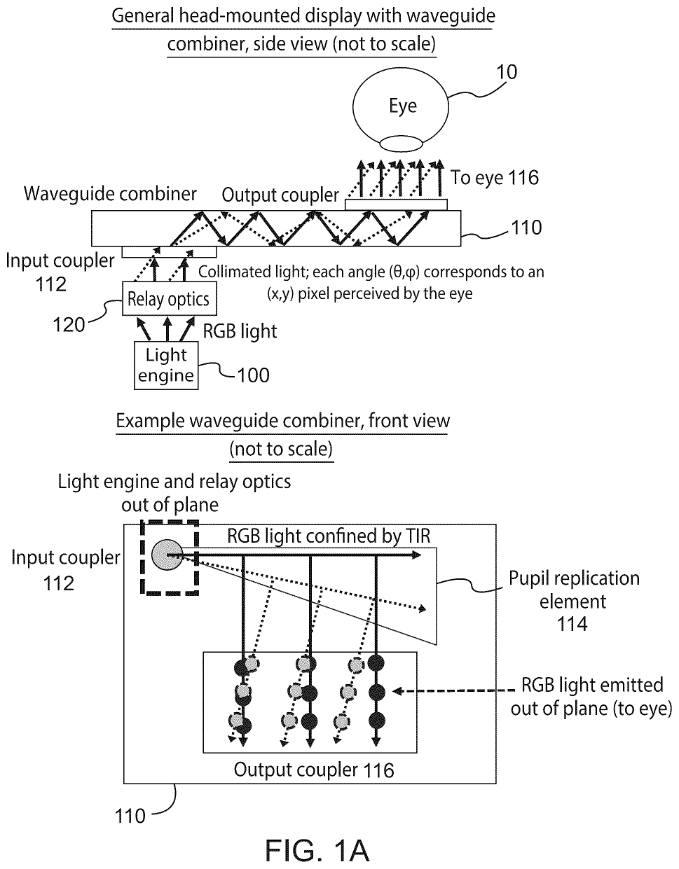

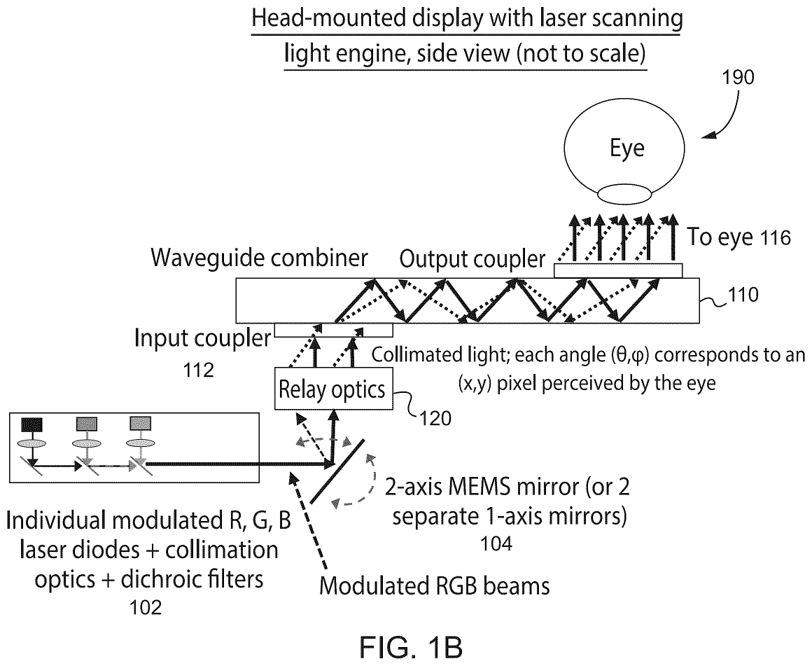

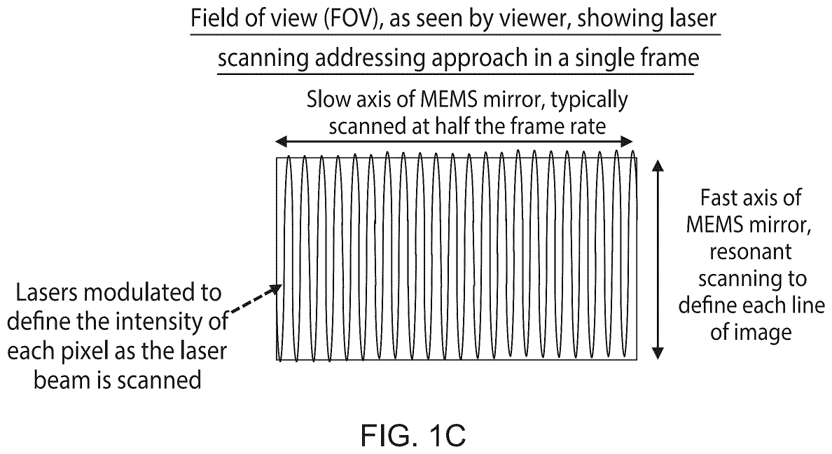

### DETAILED DESCRIPTION

Photonic Integrated Circuit Chips with Off-Chip Actuators

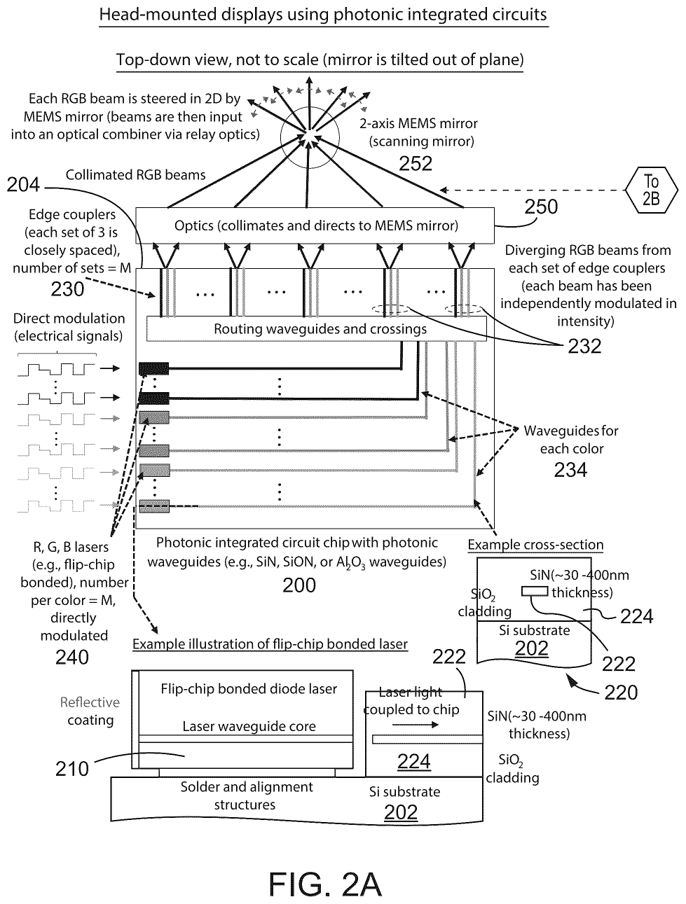

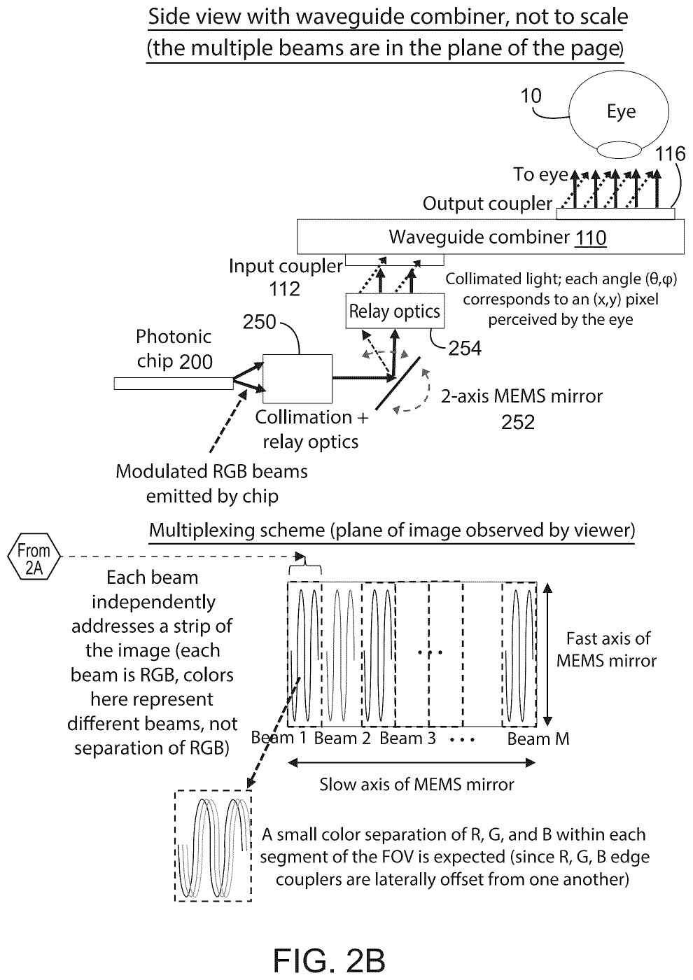

FIGS. 2A and 2B show an inventive visible-light photonic integrated circuit chip 200, also called a photonic circuit chip, a photonic chip, or simply a chip, suitable for use in a head-mounted display or near-eye display. Multiple red (R), green (G), and blue (B) solid state lasers 210 are flip-chip bonded (or otherwise co-packaged) to the photonic integrated circuit chip 200, which is fabricated in a silicon substrate 202. There may be one laser 210 per color per eye and possibly at least two lasers per color (red, green, and blue) per eye 10 (i.e., at least twelve lasers for binocular displays, and at least six lasers for monocular displays). If the photonic integrated circuit chip 200 does not include any optical switches, the FOV addressing can be increasingly parallelized by adding more intensity-modulated lasers (but the chip 200 may become more complicated/harder to fabricate/more expensive with too many lasers). Four to eight lasers 210 per color per eye is a practical number for the near future, and tens of lasers per color per eye is also possible.

Chips with laser arrays could be coupled to a photonic integrated circuit chip. There can be multiple independently-controllable lasers fabricated on the same laser array chip at a precise pitch. Coupling chips with laser arrays may be a practical way to couple many lasers to the photonic integrated circuit chip.

Light from the lasers is coupled into waveguides 220 on the photonic integrated circuit chip 200 (e.g., by butt-coupling). The waveguides 220 have higher-index cores 222 (e.g., SiN cores that are 30-400 nm thick) surrounded by lower-index cladding 224 (e.g., SiO₂ cladding). The waveguides 220 are routed to a facet 204 of the chip 200 where the light is emitted by edge couplers 230 (devices designed to emit light from the chip facet with specific beam properties). The lasers 210 are directly modulated (as in conventional laser-scanning displays), and each laser 210 corresponds to one edge coupler 230 on the output facet 204—forming a set of independent intensity-modulated beams emitted from the facet 204 of the photonic circuit chip 200. The beams are collimated and redirected to a two-axis scanning mirror 252 using free space optics 250 (e.g., lenses, lens arrays, curved mirrors). The beams are then coupled into an optical combiner 110 via relay optics 254 (e.g., lenses), and finally, output toward the eye.

FIG. 2B shows that each beam addresses a different slice of the user's field of view (FOV). Since each beam is independently intensity-modulated, the beams address the different slices of the FOV in parallel. (The beams can also be scanned in a spiral, Lissajous, or other pattern instead of in a raster pattern as in FIG. 2B.) Since each beam addresses a smaller section of the FOV, a sufficiently large number of beams enables fine spatial resolution and wide FOVs with relatively low fast-axis mirror frequencies and laser modulation rates. This is illustrated by an example in the table below, which compares a laser-scanning approach with eight beams per color per eye and a conventional laser-scanning approach with one beam per color per eye:

4k resolution (3840 pixels by 2160 pixels), FOV = 64° ×
36° (73.4° diagonal), 120 Hz frame rate

| | Inventive | | Conventional |
|---|---|---|---|
| | Approach | | Approach |
| | (8 beams per | | (1 beam per |
| | color per eye) | | color per eye) |
| Fast-axis mirror frequency | 28.8 | kHz | 230 kHz (requires |
| | | | very small mirror |
| | | | diameters) |
| Fast-axis mirror deflection | ±9° | | ±9° |
| Slow-axis mirror frequency | 60 | Hz | 60 Hz |
| Slow-axis mirror deflection | ±2° | | ±2° |
| Maximum laser modulation rate | 125 | MHz | 1 GHz (requires |
| | | | complex electronics) |

Overall, for a given combination of resolution and FOV, the fast-axis mirror scan frequency, laser modulation rate, and slow-axis deflection range decrease as the number of beams increases. This alleviates the tradeoff between (fast-axis mirror scan frequency, laser modulation rate) and (resolution, FOV). In this approach, high-resolution and wide-FOV displays are possible with reduced fast-axis mirror scan frequencies (e.g., 5-30 kHz, depending the mirror diameter), and hence, larger mirrors and larger beam diameters (e.g., 1-3.5 mm mirror/beam diameters). Scanning frequencies above 20 kHz are advantageous because they do not produce audible tones. Larger beam diameters increase spatial/angular resolution (both because the beam divergence is reduced, and in the case of diffractive waveguide combiners, the diffractive gratings perform better with larger beams). Larger mirrors increase resolution since the mirror size limits the beam size.

The edge couplers, optics, and facet-to-optics and optics-to-mirror distances may be designed to achieve the appropriate beam diameters for this approach. The reduced laser modulation rates of this approach also reduce the complexity of the drive electronics. There may be multiple laser drivers for multiple lasers. However, there may be practical advantages to having multiple lower bandwidth laser driver integrated circuits compared to fewer high frequency (e.g., ≥1 GHz) laser drivers (e.g., in terms of cost, specifications for control and synchronization electronics, and issues related to laser dynamics, such as laser relaxation resonance frequency causing ringing in the laser modulation).

Multiple laser beams may also be generated by discrete laser components. However, this is not a scalable approach because the increasing number of discrete lasers, lenses, and filters poses enormous alignment, packaging, and miniaturization problems. By contrast, the inventive approach relies on wafer-scale manufacturing technology and is scalable. The photonic circuit chips can be manufactured using wafer-scale fabrication processes, and flip-chip bonding of multiple laser dies to photonic circuit chips can be a high-yield wafer-scale assembly process (without lenses for coupling the lasers to the photonic circuit chip).

The edge couplers 230 in FIG. 2A are arranged in subsets 232, with each subset 232 including separate edge couplers 230 for emitting R, G, and B beams. The subsets 232 are arrayed at an inter-subset pitch, and the edge couplers 230 within each subset 232 are arrayed at an intra-subset pitch. In FIG. 2A, subsets 232 of edge couplers 230 for R, G, and B are on a small intra-subset pitch, and the inter-subset pitch between subsets 232 is larger. The intra-subset pitch sets the separation/offset between R, G, and B beams within an FOV slice in FIG. 2B. This offset can be made small using a small intra-subset pitch, and the minimum intra-subset pitch is limited by optical crosstalk between edge couplers 230. (A reasonable range of minimum intra-subset pitches is 2-20 μm. The inter-subset pitch may about three times the intra-subset pitch (6-60 μm) if separate edge couplers 230 are used for R, G, and B.) Furthermore, the offset can be compensated by adjusting the image data input to the display system. The larger inter-subset pitch is designed to achieve a certain FOV. Together with the collimation/relay optics, the inter-subset pitch sets the spacing of FOV slices as shown in FIG. 2B. Intra-subset pitches tend to be limited by optical crosstalk. Low optical confinement waveguides (for lower numerical aperture (NA) edge couplers) have larger pitches to avoid crosstalk. For SiN waveguides, intra-subset pitches of 3-15 μm are reasonable.

Inter-subset pitch is practically determined by the number of edge couplers 230 since increasing the number of edge couplers 230 usually involves increasing the numbers of lasers 210, on-chip modulators, and/or on-chip switches, depending on the exact architecture. To achieve a large field of view with a reasonable NA, the edge couplers 230 should span >1 mm (and likely about 3-8 mm) along the facet 204 of the chip 200. With 101 edge coupler subsets 230 spanning 4 mm along the chip facet 204, the inter-subset pitch is 40 μm, which should have very low crosstalk (for SiN waveguide cores 222). For photonic integrated circuit chips 200 with on-chip actuators, the inter-subset pitch may also be determined by the design/size of the actuators.

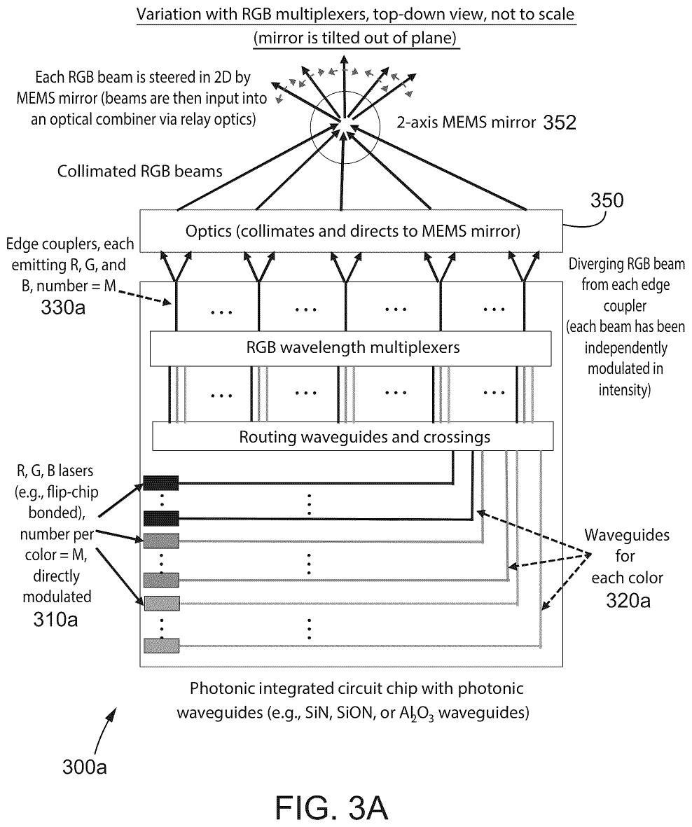

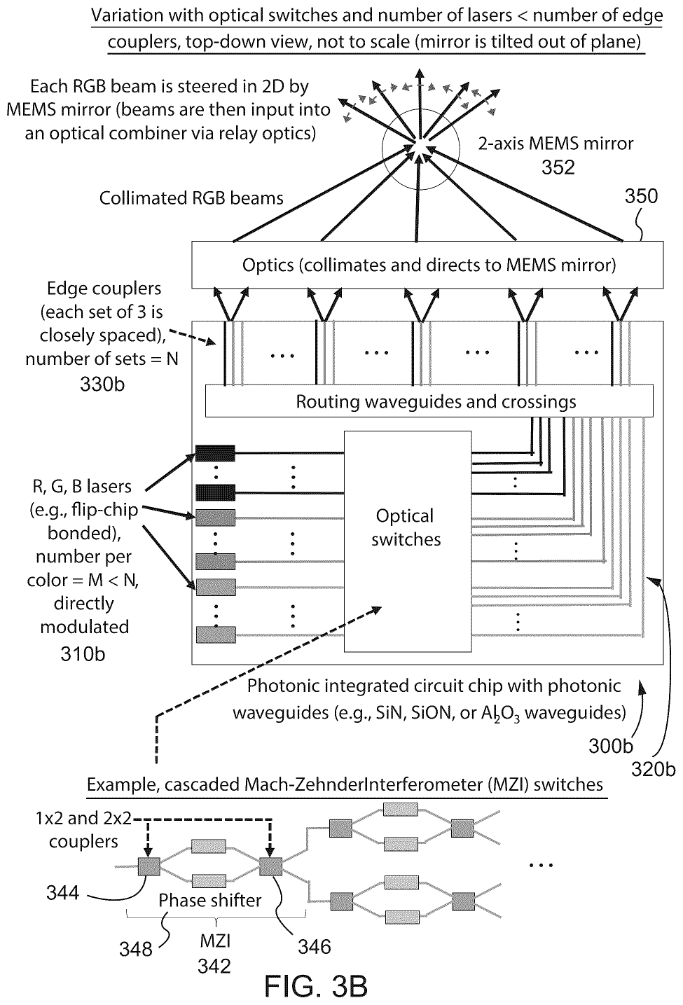

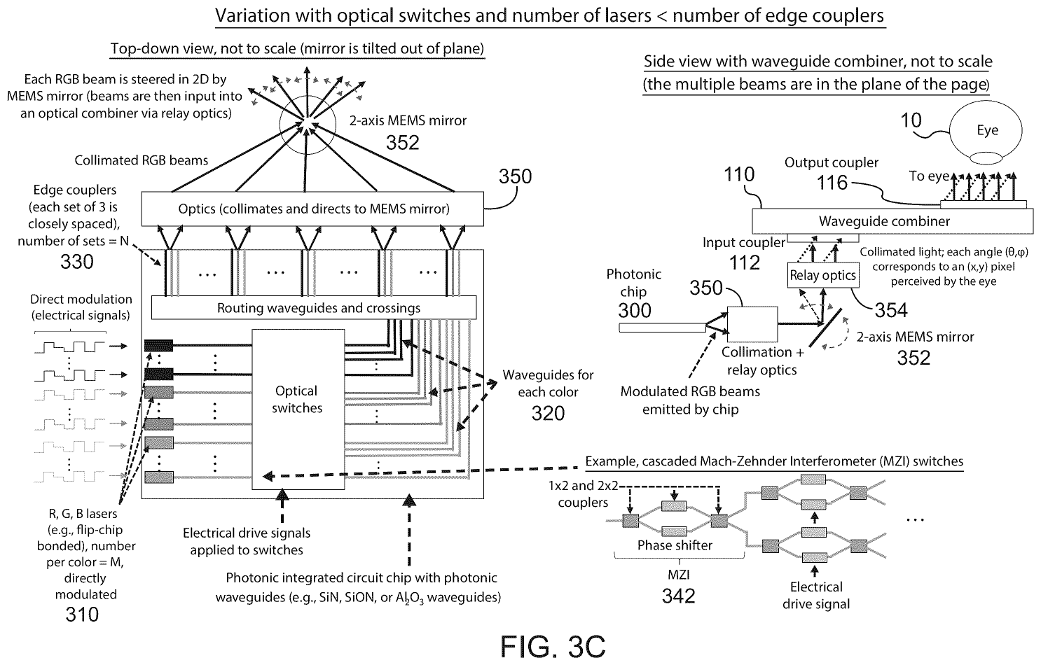

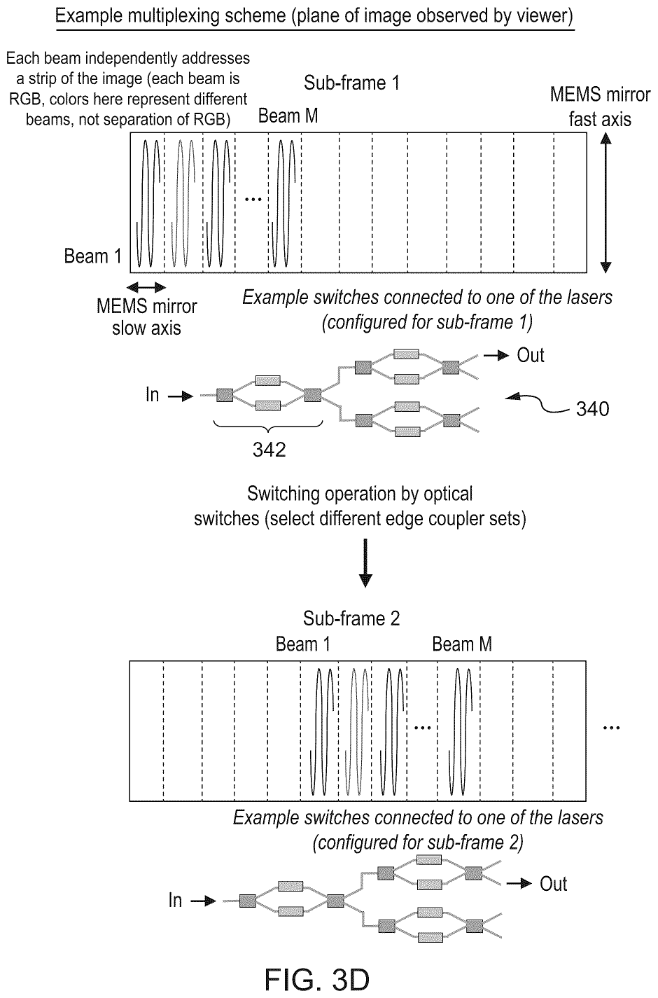

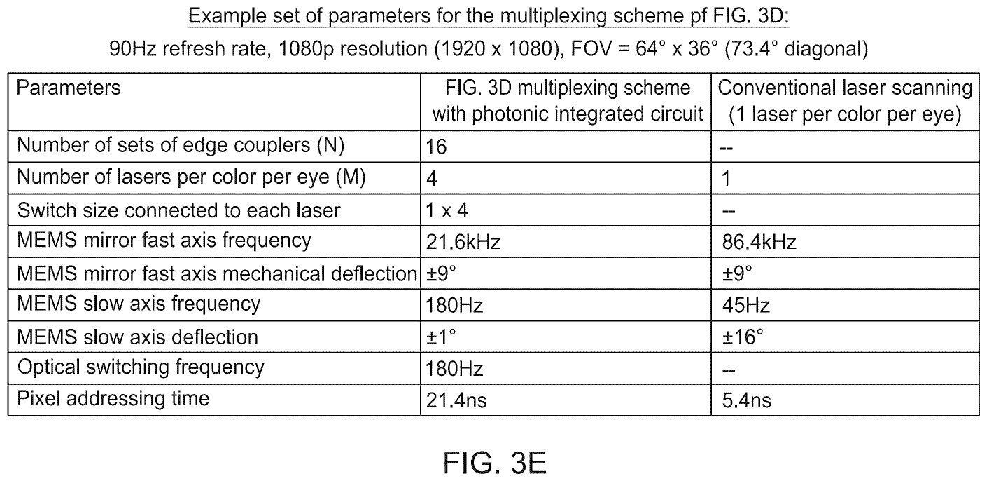

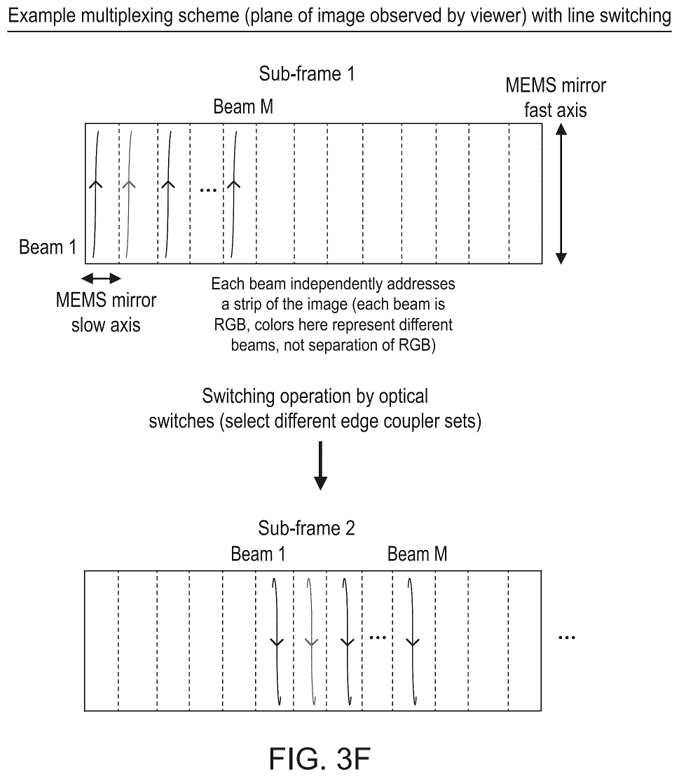

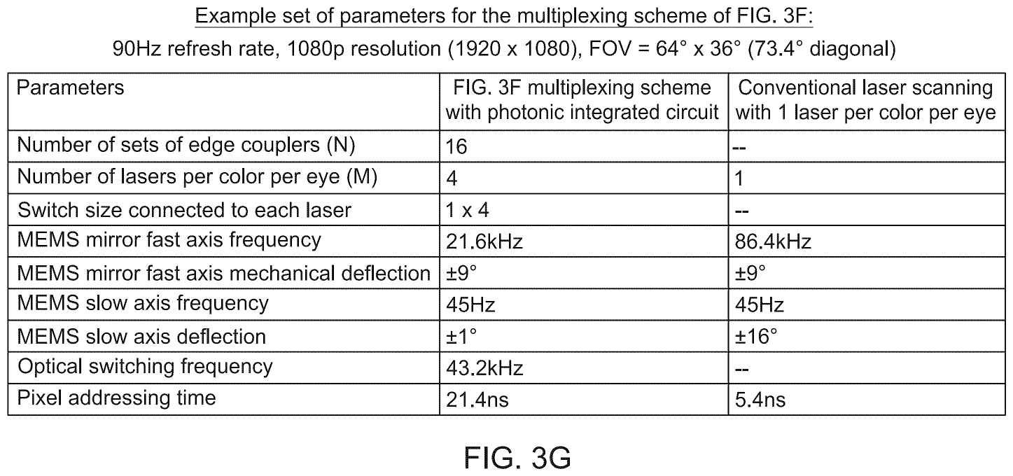

FIGS. 3A and 3B show variations of the photonic integrated circuit chip. The first variation (chip 300a), in FIG. 3A, uses on-chip RGB wavelength multiplexer devices 332 to combine light from one set of R, G, and B lasers 310a and waveguides 320a onto each edge coupler waveguide 330a. The emitted light from each edge coupler 330a includes coaxial R, G, and B beams, in contrast to the photonic integrated circuit chip 200 in FIG. 2A, which uses separate edge couplers 230 for R, G, and B beams. This approach may eliminate the offset between R, G, and B beams shown in FIG. 2A at the expense of additional photonic integrated circuit complexity and optical loss. Relay optics 350 collimate the coaxial beams and direct them to a two-axis MEMS mirror 352, which scans the coaxial beams across the FOV.

In principle, packing more beams into the same space may yield a finer spatial resolution since the density of waveguides 320a and edge couplers 330a can be higher. This may also help reduce the actuator size (for higher actuation speeds). However, achieving a reasonable field of view from the waveguide array may involve spanning distances along the facet of millimeters. For photonic integrated circuit chips with about 100 waveguides on actuators, the inter-subset pitch should not limit the resolution.

FIG. 3B shows a second variation 300b of the photonic integrated circuit chip where the number of edge couplers 330b per color exceeds the number of lasers 310b per color; waveguides 320b guide the laser beams to and from on-chip optical switch devices 340 that are used to select the set of edge couplers 330b addressed. The on-chip optical switch devices 340 can be implemented in any of a variety of ways, including as a network of cascaded Mach-Zehnder interferometers 342, each of which includes phase shifters 346 whose inputs and outputs are connected to 1×2 couplers 344 or 2×2 couplers 348 as appropriate. Increasing the number of edge couplers 330b beyond the number of lasers 310b does not further increase the number of independent beams but can further reduce the movement of the slow axis of the scanning mirror 352 to achieve a given FOV.

FIGS. 3C-3E show the photonic integrated circuit chip 300b of FIG. 3B together with a waveguide combiner 110, an example multiplexing scheme, and an example set of parameters for this multiplexing scheme, respectively. FIGS. 3F and 3G show an alternative multiplexing scheme with line switching and a set of parameters, respectively, for the photonic integrated circuit chip 300. In both multiplexing schemes, the on-chip switches 340 are driven synchronously with the MEMS mirror 352 and laser modulation. Such configurations enable performance benefits related to a large number of edge coupler emitters 330 without using a large number of lasers 310. Essentially, the slow-axis of the MEMS mirror 352 and on-chip switches 340 work together to trace out the “overall slow-axis” of the display system.

In the configuration in FIGS. 3D and 3E, M beams (for each color) corresponding to the M lasers 310 (for each color), trace out slices of the field of view via deflection by the two-axis MEMS mirror 352. The slow-axis of the MEMS mirror 352 operates at a frequency larger than the refresh rate of the display such that sub-frames are addressed by the set of beams. For each sub-frame, the optical switches 340 are driven to route the input laser signals to a different set of edge couplers 330. The MEMS mirror fast axis frequency, MEMS mirror slow axis deflection, and laser modulation frequency are significantly reduced compared to conventional laser scanning, and in FIG. 3E, only four lasers per color per eye 10 and a 1×4 switch 340 connected to each laser 310 provides significant performance benefits. This comes at the expense of a higher MEMS mirror slow axis frequency compared to conventional laser scanning displays, but the frequency remains practical. Overall, compared to conventional laser scanning, the approach in FIGS. 3D and 3E scales down the slow-axis mechanical deflection by a factor of 1/(number of sets of edge couplers), scales down the MEMS mirror fast axis frequency by 1/(number of lasers per color per eye), scales up the pixel addressing time by a factor of the number of lasers per color per eye, and scales up the MEMS mirror slow axis frequency by a factor of (number of sets of edge couplers/number of lasers per color per eye).

FIGS. 3F and 3G show a line switching configuration. The on-chip switches 340 are driven at twice the MEMS mirror fast axis frequency, but the MEMS mirror slow axis frequency is not increased compared to conventional laser scanning display.

In calculations of the switching frequency, it is assumed that the rise/fall time of the optical switches 340 is much less than the time for a single line of the display to be scanned (requiring a bandwidth of the switches much larger than the switching frequency). In practice, this constraint may be alleviated by the slow axis of the MEMS mirror 352 overshooting the extent of each slice of the field of view. No laser light is applied during this overshoot time; the overshoot period is used to drive the switches 340 to a new state for routing the laser signals to a new set of edge couplers 330. Alternatively, the optical beams may be scanned during the forward pass of the MEMS mirror slow axis, the optical beams may be turned off during the backwards pass of the MEMS mirror slow axis, and the optical switches 340 may be driven to a new state during the backwards pass. The first method uses a larger slow axis mechanical deflection and the second method uses a doubling of the slow axis frequency and switching frequency. With these methods, the optical switch bandwidths for these approaches may be low enough to be compatible with thermo-optic switches or on-chip MEMS switches.

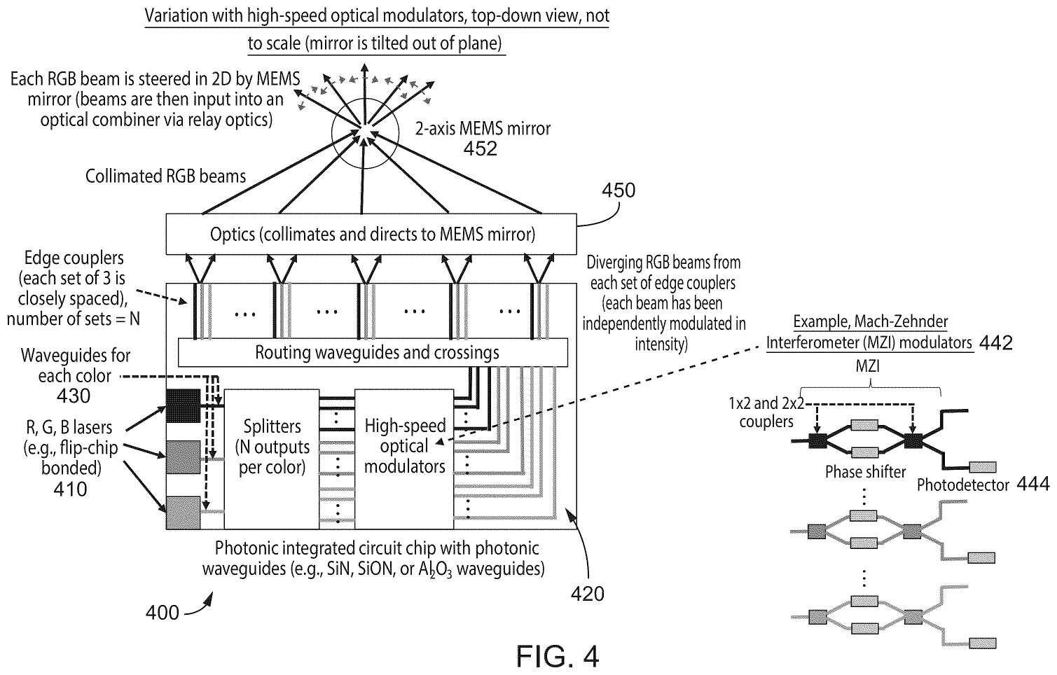

FIG. 4 shows a third variation 400 of the photonic integrated circuit chip. High-speed optical modulators 442 in the photonic integrated circuit 400 modulate the intensity of the laser light (instead of or in addition to direct modulation of the laser diodes as in FIGS. 2A, 3A, and 3B). Optical splitting devices 440 split light from each laser 410 into multiple waveguides 420, each of which is coupled to a corresponding optical modulator 442, which may modulate the light at modulation rates of about 100-500 MHz. The waveguides 420 guide modulated red, green, and blue light from the optical modulators 442 to the edge couplers 430, which are grouped in subsets of three (red, green, and blue) and emit light into free space. Relay optics 450 collimate the modulated beams and direct them to a two-axis MEMS mirror 452, which scans the modulated beams across the FOV.

Suitable optical splitting devices 440 include multimode interference (MMI) couplers, directional (evanescent) couplers, star couplers, or cascaded 1×2 splitting devices. The optical modulators 442 may be formed from mechanical (MEMS) phase shifter devices, semiconductors such as gallium nitride (GaN), or electro-optic materials such as barium titanate (BTO), lithium niobate, or lithium tantalate. Phase shifters can be integrated into interferometers for modulating intensity. For instance, the optical modulators 442 can be implemented as Mach-Zehnder modulators with phase shifters in each arm and photodetectors 444 connected to the unused outputs as shown at lower right in FIG. 4

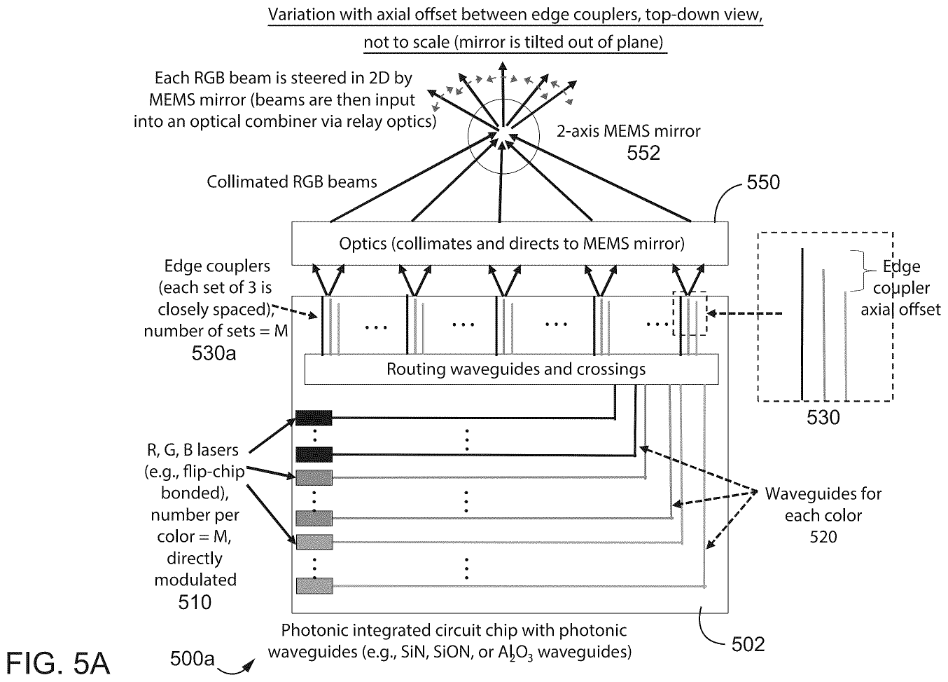

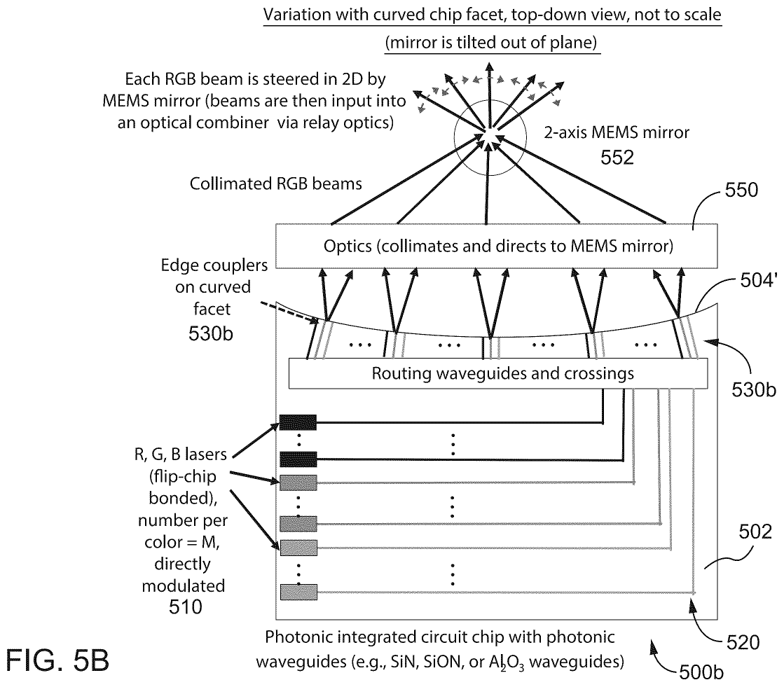

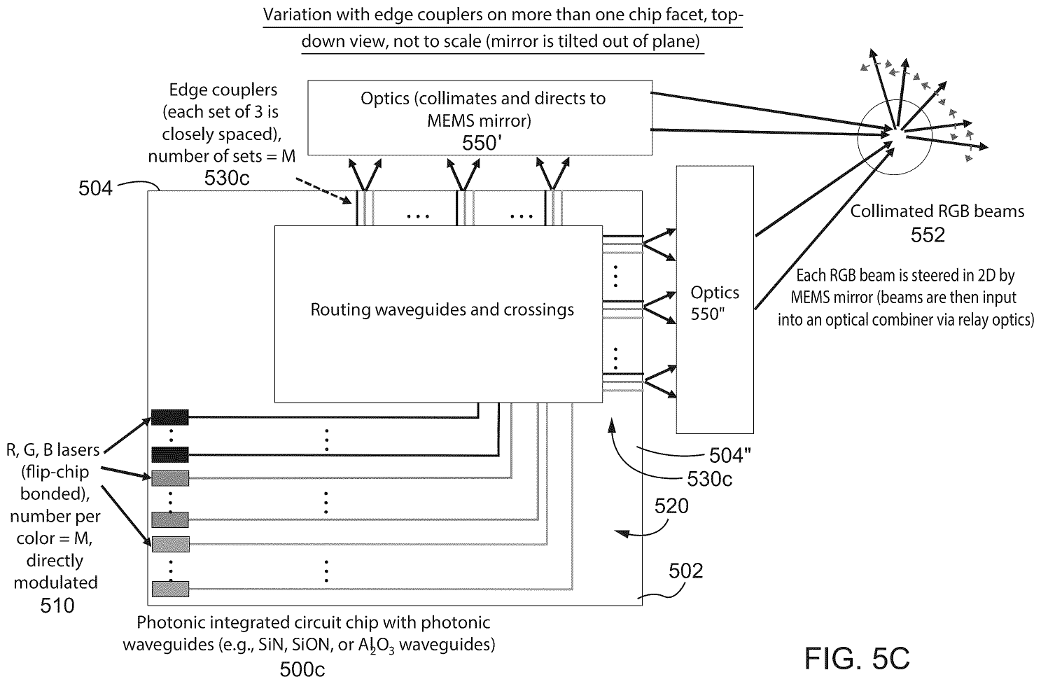

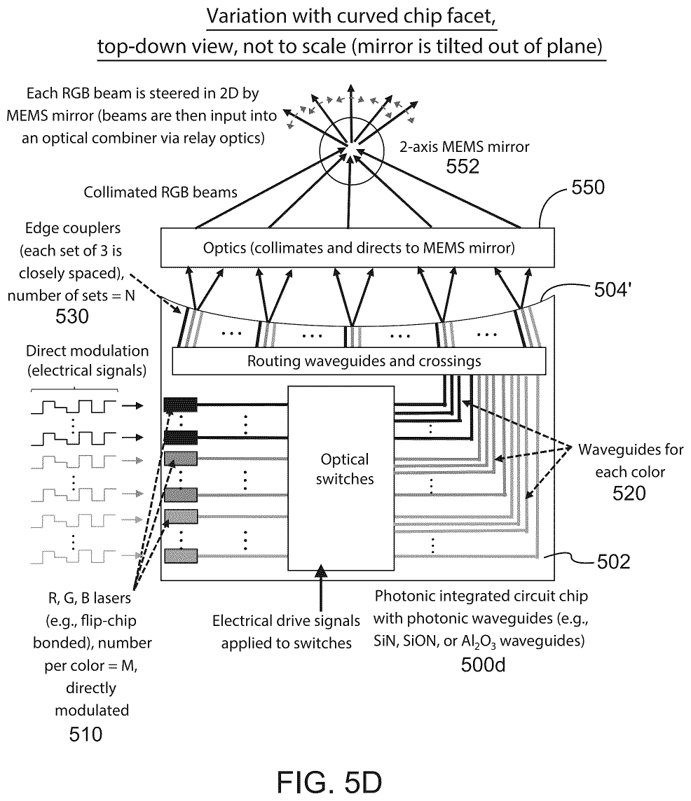

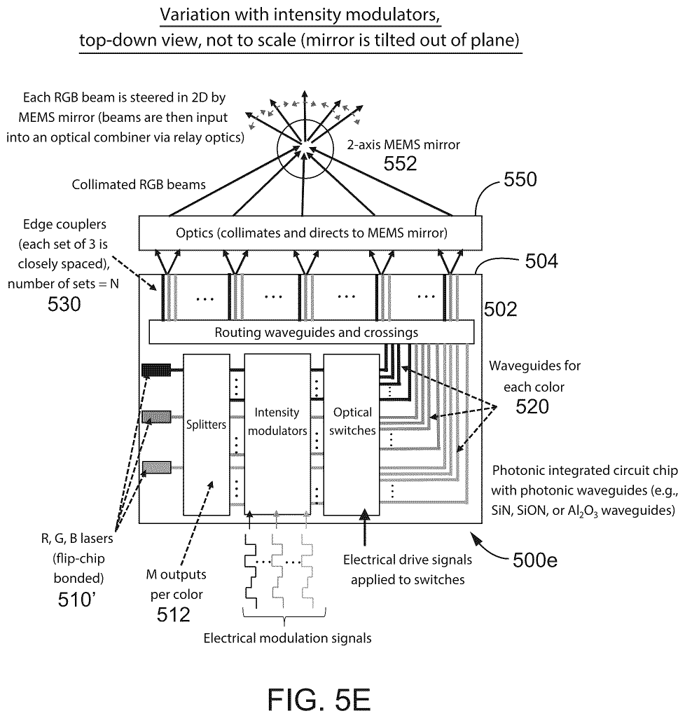

FIGS. 5A-5E show additional variations 500a-500e of photonic integrated circuit chips for head-mounted and near-eye displays. Each of these chips 500a-500e includes lasers 510 and waveguides 520 integrated on a substrate 502. The chip 500a in FIG. 5A includes edge couplers 530a that emit R, G, and B beams that are axially offset, with the axial offsets selected to correct chromatic aberrations (e.g., wavelength-dependent focal lengths) of the collimation/relay optics 550. Again, a two-axis MEMS mirror 552 scans the collimated beams from the relay optics 550 across a FOV.

The chip 500b in FIG. 5B has edge couplers 530b on a curved facet 504′. The facet curvature can be a useful degree of freedom for the optical system design, potentially improving the performance of the collimation/relay optics 550 and/or alleviating design challenges. In addition, as in FIG. 5C, edge couplers 530c can be defined along multiple facets 504 and 504″ of the photonic integrated circuit chip 500c, another potentially useful degree of freedom for the optical system design. Relay optics 550 and 550″ collimate and direct the beams emitted from the different facets 504 and 504″ to the two-axis MEMS scanning mirror 552.

FIG. 5D shows a photonic integrated circuit chip 500d with edge couplers 530 arrayed along a curved facet 504′. The photonic integrated circuit chip 500d includes directly modulated RGB lasers 510 which are coupled to optical switches 516 that switch the laser beams among waveguides 520 and edge couplers 530 integrated with a substrate or wafer 502. The edge couplers 530 can be grouped in subsets, e.g., each with a red, a green, and a blue output, as shown in FIG. 5D. Relay optics 550 collimate these outputs and direct them to a two-axis MEMS mirror 552 for scanning across the FOV.

As mentioned above with respect to FIG. 5B, the curvature of the curved facet 504′ is a degree of freedom that can be used for reducing the complexity of the collimation and relay optical elements 550. In the practical configuration shown in FIG. 5D, the curved facet 504′ curves inward and the edge couplers 530 are normal to the curved facet 504′ (possibly with a small angular offset that varies with position along the curved facet 504′). Beneficially, there are practical fabrication methods for defining such a curved facet 504′ (e.g., etch deep trenches in the wafer 502 to define the outline of the chip 500d, then thin the whole wafer 502 to a thickness less than the trench depth to expose the trenches—the released chip 500d can then have a lithographically defined shape).

FIG. 5E shows a photonic integrated circuit chip 500e with lasers 510′ whose outputs are externally modulated by high-speed intensity modulators 514 integrated with the substrate 502. Splitters 512 integrated with the substrate 502 couple the outputs of the lasers 510′ to the intensity modulators 514, and integrated optical switches 516′ couple the modulated outputs of the intensity modulators 514 into the waveguides 520, which guide the light to edge couplers 530 array along a facet 504 (if desired, the facet 504′ could be curved as in FIG. 5D). Using optical splitters 512 and optical intensity modulators 514 instead of direct laser modulation can reduce the number of laser chips 510′. In this configuration, the intensity modulators 514 on the photonic integrated circuit chip perform pixel-to-pixel intensity modulation of the laser scanning display.

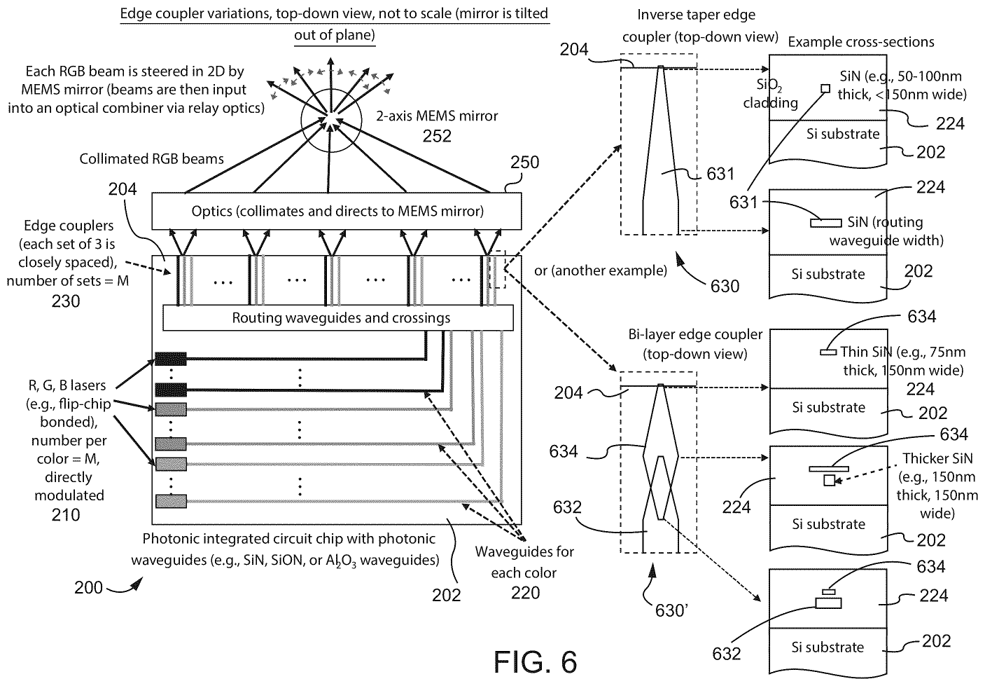

FIG. 6 shows the edge couplers 230 (330, 430, and/or 530) in greater detail. The edge couplers 230 may be an inverse taper design 630, as shown at upper right, wherein the waveguide core 631 has a width that decreases toward the facet 204. The edge coupler 230 may also rely on a bi-layer design 630′ where light transitions from a thicker waveguide layer 632 (for compact on-chip devices) to a thinner waveguide layer 634, as shown at lower right, where light emitted from the facet 204 is emitted with a relatively low divergence angle.

Overall, the edge couplers can be designed to operate together with the collimation/relay optics to achieve certain beam diameters with the chosen FOV. Moderate divergence angles may be beneficial here, since very small divergence angles take large propagation distances to reach a beam diameter of about 1-3 mm, while very large divergence angles typically involve complex high-NA collimation optics. With SiN waveguides, NAs in the range of 0.07 to 0.40 can be achieved with round beams (corresponding to half-divergence angles of 4° to 23.6°). An NA roughly in the range of 0.12-0.25 (half divergence angles of 6.9° to 14.5°) balances the size and complexity of the optics. A higher NA enables the span of the edge coupler array along the chip facet to be smaller, which reduces the range of motion for the actuators, possibly at the expense of more complicated collimation/relay optics. The refractive index and dimensions of the waveguides are degrees of freedom for engineering the NA.

In addition, the edge couplers should emit beams with equal divergences along both transverse axes (“round” beams) to simplify the design of the collimation/relay optics. This can be achieved with thin SiN or Al₂O₃ waveguides that are tapered to small widths at the facet. Given the relatively large refractive index difference between these materials and the SiO₂ cladding, this typically involves thicknesses <100 nm, which are not ideal for compact photonic devices due to the low optical confinement at such thicknesses. Alternatively, a bi-layer edge coupler can be used as in FIG. 6, where light transitions from a thicker waveguide layer (with higher optical confinement for compact devices) to a thinner waveguide layer with a thickness specifically chosen for the edge coupler. An edge coupler similar in operation to the bi-layer edge coupler may be formed from a single waveguide core material layer with a thin waveguide (formed by partial etching of the core material) coupled in-plane to a thicker waveguide with the full core material thickness. The edge coupler can be designed to shape the beams, e.g., in terms of divergence and symmetry, as understood in the art of optics.

Low-index waveguide materials (e.g., SiON or polymers) with thicknesses >1 μm are another possibility for the photonic integrated circuit and waveguides. A waveguide made of low-index material may be tapered to a width at the facet that is larger than the routing waveguide width.

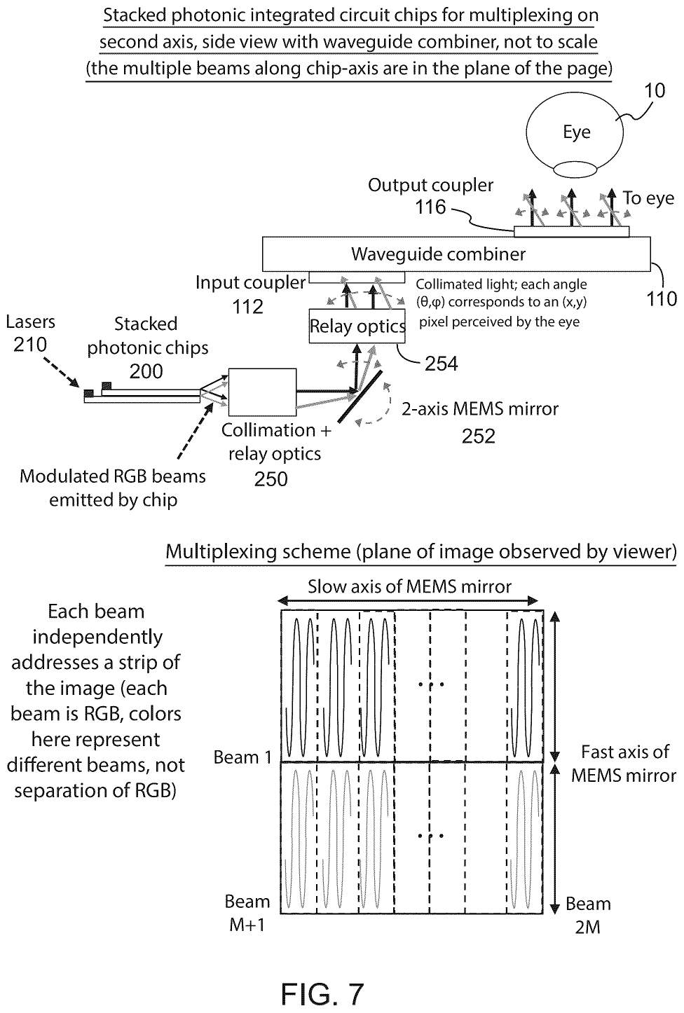

FIG. 7 shows photonic integrated circuit chips 200 stacked to form a 2D array of edge couplers 230 (shown in FIG. 2) at the facet of the chip stack. Each row of edge couplers 230 enables addressing vertical slices of FOV with multiple beams (as in FIGS. 2A, 3A, 3B, 4, 5A-5C, and 6), and the different chips 200 can address different horizontal sections of the FOV-splitting the FOV along two (orthogonal) axes. Splitting the FOV along a second axis has the added benefit of reducing the mechanical deflection of the scanning mirror 252 along the fast axis.

The facets of the different photonic integrated circuit chips 200 can be aligned to same plane as shown in FIG. 7 or to different planes, e.g., depending on the relay optics. Round collimation and relay optics (e.g., standard lenses) should work with the stacked chips. Due to the symmetry of round optics, there should be no difference in collimating and relaying light from an edge coupler laterally offset from the center axis of the optics and an edge coupler 230 vertically offset from the center axis. If the optics also correct for aberrations, then there may be additional considerations in the optics for the case of stacked chips 200.

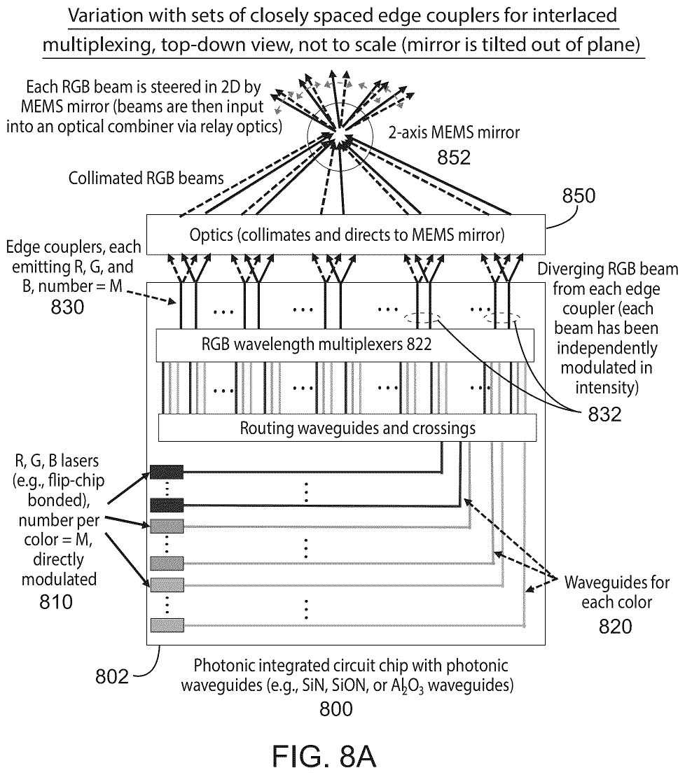

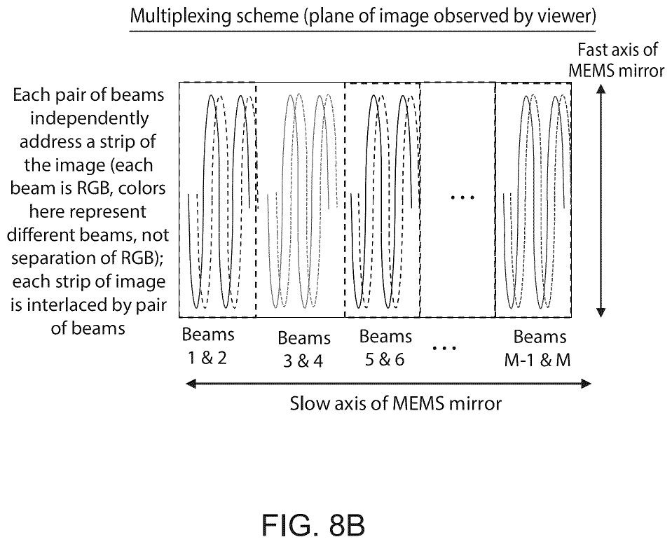

FIGS. 8A and 8B illustrate a photonic integrated circuit chip 800 that generates an interlaced or interleaved scan pattern. FIG. 8A shows the chip 800, which includes RGB lasers 810, waveguides 820, RGB wavelength multiplexers 822, and edge couplers 830 integrated on a substrate 802. FIG. 8B shows the interlaced scan pattern. The edge couplers 830 are arranged in subsets 832, with a small intra-subset pitch between edge couplers 830 within each subset 832, such that multiple independent beams address the same slice of the FOV, but with an offset. A larger inter-subset pitch is used between the subsets 832, which sets the spacing between the FOV slices. Interlacing scan patterns increases the resolution of laser-scanning displays.

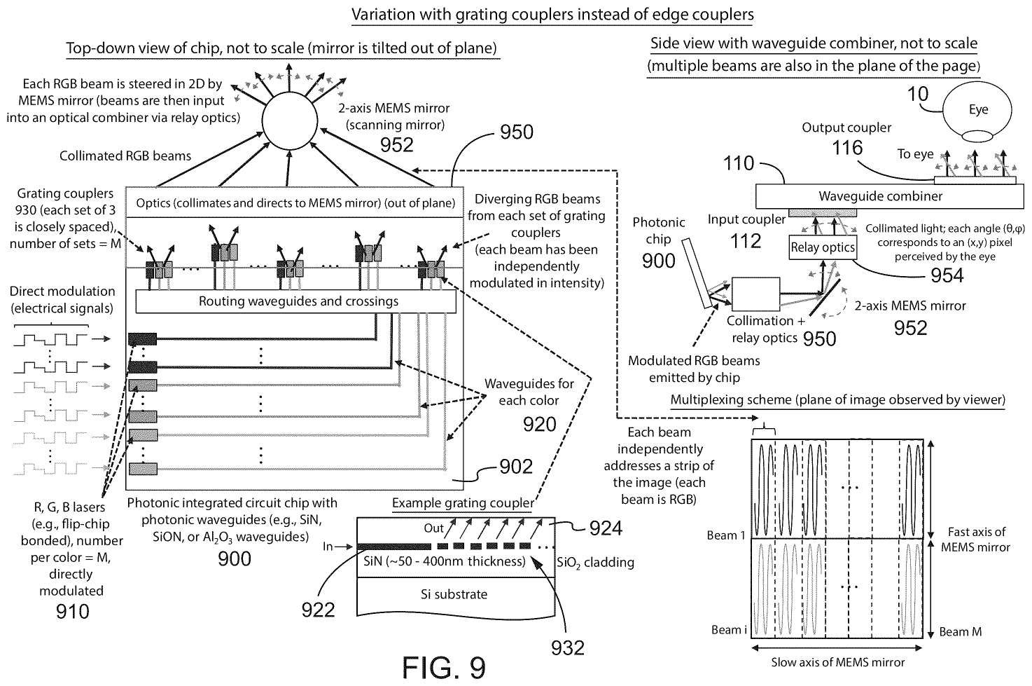

FIG. 9 shows a photonic integrated circuit chip 900 with gratings or grating couplers 930 (instead of edge couplers) for emitting light. Along with lasers 910 and waveguides 920, the grating couplers 930 are integrated into a substrate 902. The waveguides 920 have cores 922 in a cladding 924 and connect the lasers 910 to the grating couplers 930.

The grating couplers 930 are diffractive elements defined in the waveguide that can emit light out of the plane of the chip; they are often defined by etching grooves 932 (grating teeth) into the waveguide cores 922. Typically, grating couplers 930 emit light at an angle relative to the normal of the chip 900 (diffraction angle). Similar to the edge-coupled approach, the grating couplers 900 emit diverging beams that relay optics 950 collimate and relay to a scanning mirror 952, which reflects them via additional relay optics 954 to the waveguide combiner 110. The grating couplers 930 may emit round beams to simplify the collimation/relay optics 950, and considering the emission angles of the grating couplers 930, the projection of the beams onto the transverse plane of the collimation/relay optics 950 may be designed to be round.

The width and strength of the grating couplers 930 may also be engineered to achieve a certain divergence angle that is compatible with the collimation/relay optics 950. As in the edge-coupled approach, each row of grating couplers 930 splits the FOV into slices along one axis. In contrast to the edge-coupled approach, multiple rows of grating couplers 930 can be defined in the photonic integrated circuit chip 900, splitting the FOV along a second axis. With focusing grating designs, where the emitted beam is focused out of the plane of the chip 900 (e.g., by curving the grating teeth and using a non-uniform grating period), it may be possible to compensate for axial distance offsets between rows of grating couplers 930 emitting at an angle relative to the chip normal.

Photonic Integrated Circuit Chips with Integrated Actuators

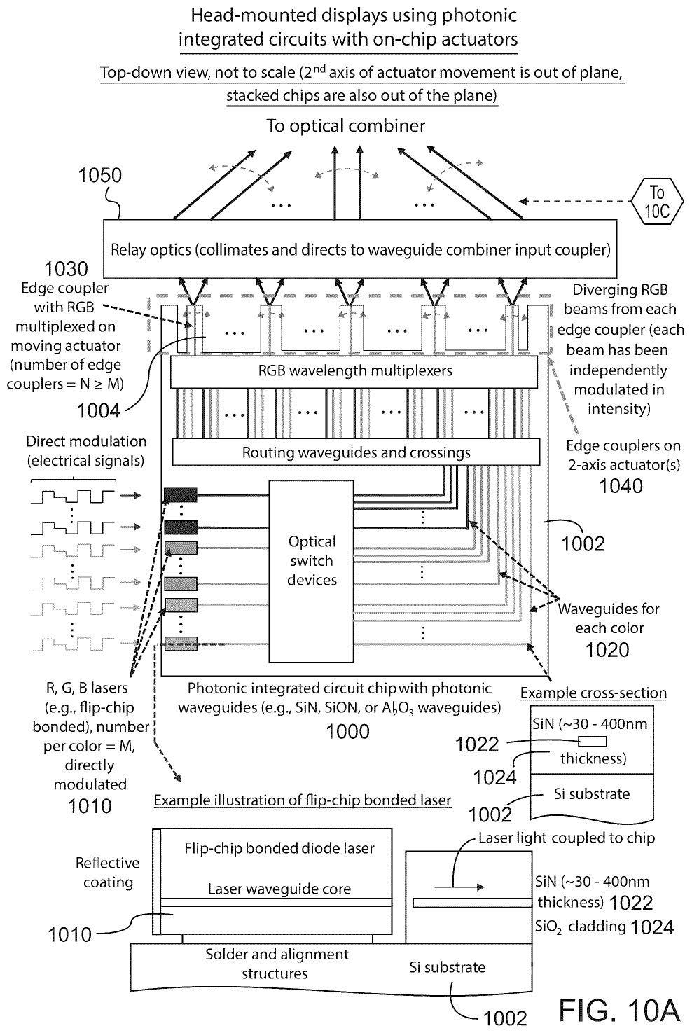

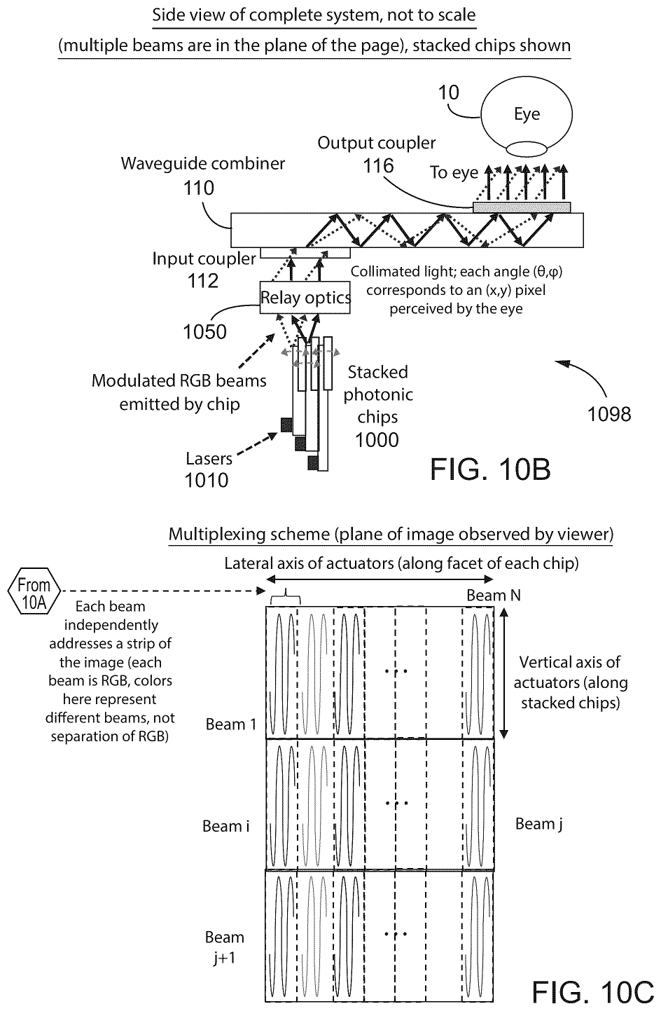

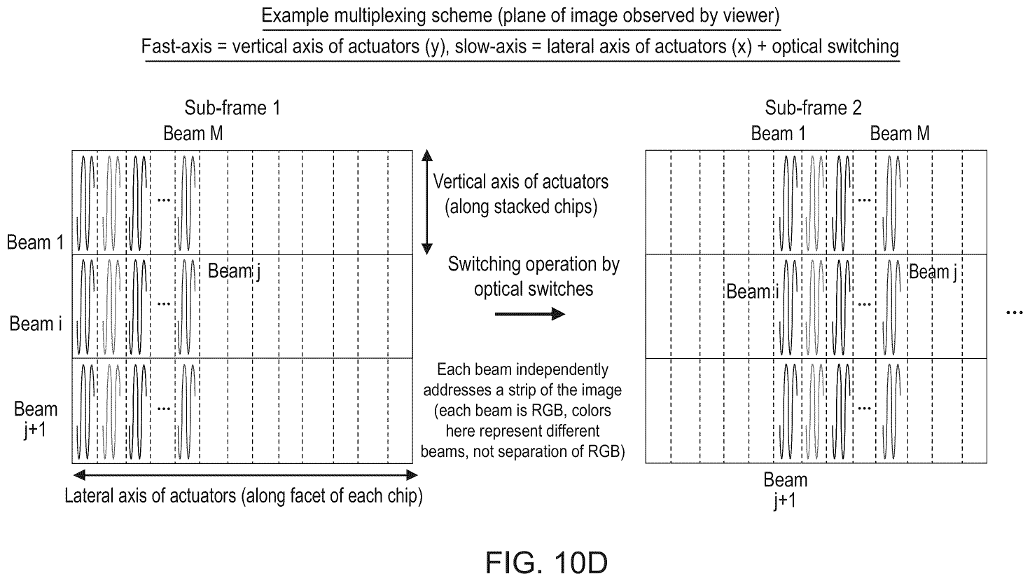

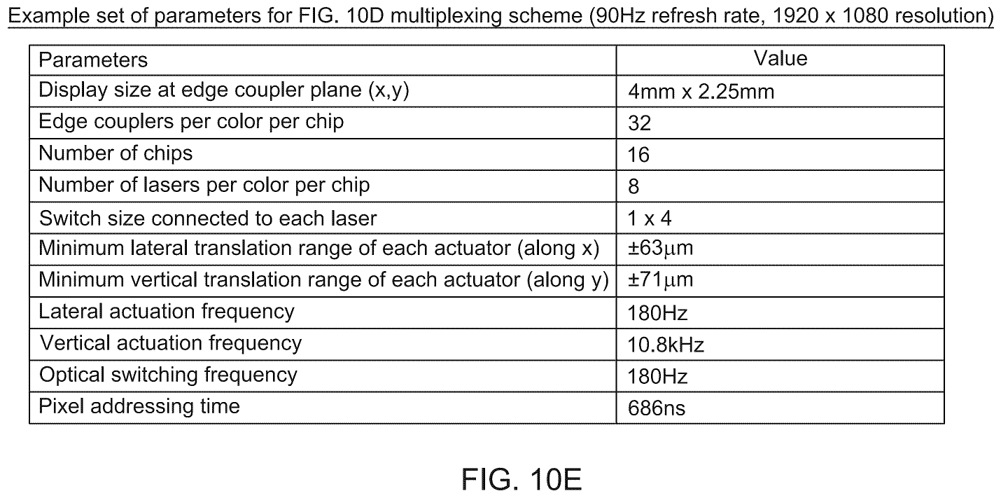

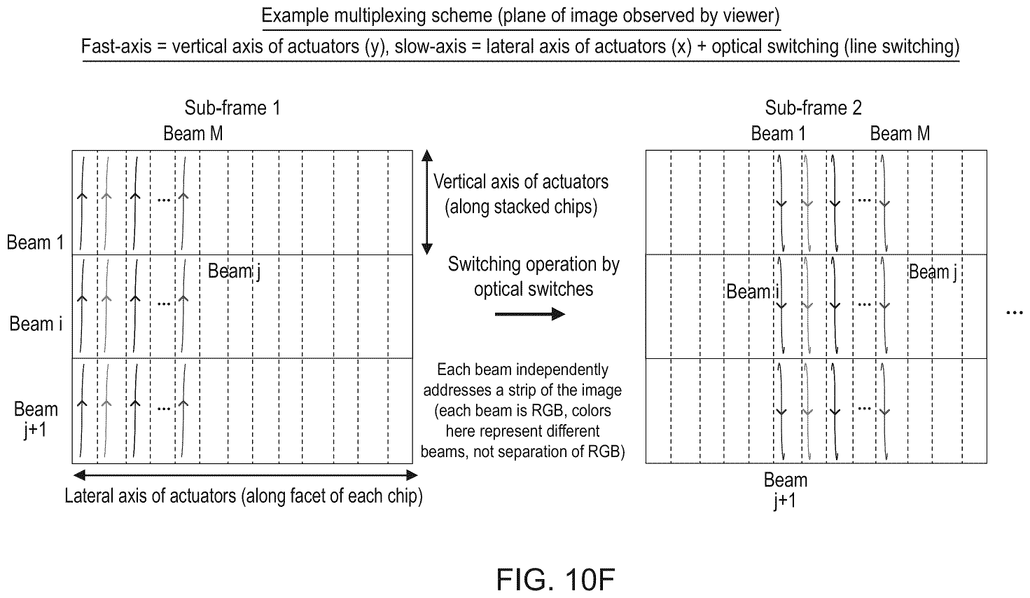

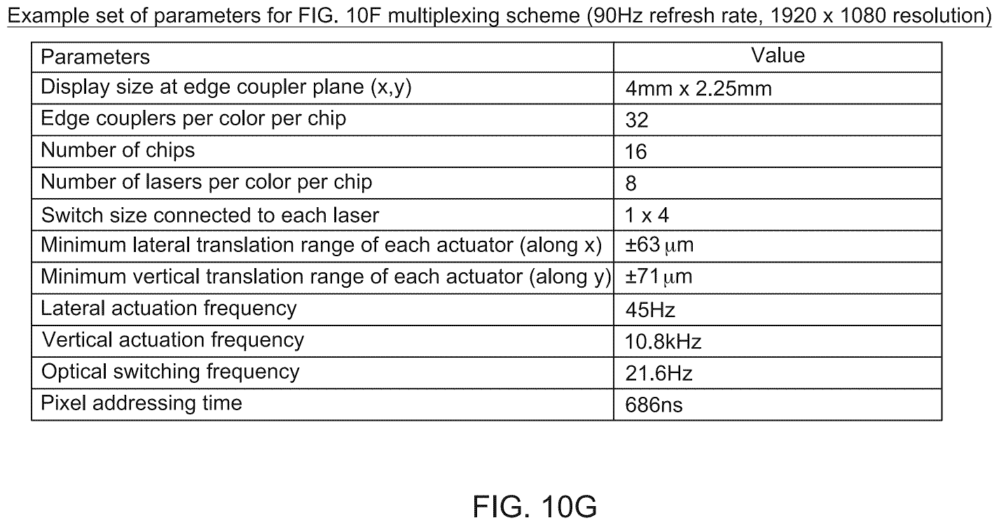

FIGS. 10A-10C show a photonic integrated circuit chip 1000 for a head-mounted or near-eye display with edge couplers 1030 and actuators 1040 that move or scan the edge couplers 1030 instead of scanning mirrors. Again, lasers 1010 packaged with the photonic integrated circuit chip 1000 (possibly by flip-chip bonding) are coupled to on-chip optical waveguides 1020, which include SiN cores 1022 surrounded by SiO₂ cladding 1024 on a substrate 1002, as shown in FIG. 10A. A series of optical switch devices 1012 on the chip 1000 routes the light in the waveguides 1020 to RGB multiplexers 1022 that couple different red, green, and blue beams onto each of the edge couplers 1030 on the facet 1004 of the chip 1000 for emitting the light into free space or a low-pressure chamber or cavity. This facet 1004 of the chip 1000 also has actuators 1040 that can translate the edge couplers 1030 and hence the beams emitted by the edge couplers 1030 along two axes.

Several chips 1000 can be stacked together to form a laser-scanning display 1098 as shown in FIG. 10B. These stacked chips 1000 emit beams that are routed through relay optics 1050 and coupled into an optical combiner (e.g., a waveguide combiner 110) that expands the beams (e.g., by pupil replication) and couples them out toward the eye 10. The different beams address different portions of the FOV observed by the viewer as shown in FIG. 10C.

Whether the horizontal axis is fast scanning or slow scanning depends on many considerations. In many displays, for example, the horizontal dimension has a larger FOV than the vertical dimension. With some actuator designs, the fast axis may have a smaller range of motion than the slower axis, and it may be advantageous for the fast axis to correspond to the vertical axis of the user. In other designs, such as the 2D array of actuators 1040 with the slow axis out of the plane of each chip 1000 as shown in FIGS. 10A-10C, the slow axis FOV may be more limited (e.g., limited by number of stacked chips 1000), so performance may be better if the slow axis corresponds to the vertical axis of the user. In other systems, depending on the specifics of the optical combiner, there may be reasons for the fast and slow axis to be along diagonals of the user's FOV.

Synchronized movement of the edge couplers 1030 by the actuator(s) 1040, driving of the optical switches 1012, and direct modulation of the lasers 1010 form the images within each slice of the FOV. The edge couplers 1030 can also move independently or in subsets. There is a tradeoff here between the amount of independence and number of drive signals. There may be practical advantages to moving edge couplers 1030 in subsets (e.g., smaller actuators that can move faster, and capability to compensate for fabrication defects by adjusting drive signals). Multiple photonic chips 1000 may be stacked to divide the FOV along the second axis, e.g., as shown in FIG. 10C. By using multiple independently modulated 1010 lasers per color, parallelization of the laser scanning is achieved, enabling laser scanning displays with fine spatial resolution and wide FOV.

The scan rates and scan ranges depend on the design of the actuator 1040. Generally, 1-50 kHz is a reasonable range for fast axis scanning. When scanning multiple beams, a lower fast axis frequency range of about 1-20 kHz is reasonable. Similarly, 60 Hz to 1 kHz is a reasonable range for the slow axis scan rate. Often the slow axis can scan at the refresh rate of the display (typically 60-120 Hz). The scan ranges in the plane of the chip 1000 can be about 5-40 μm. Since there can be many more emitters (e.g., edge couplers 1030 or grating couplers) in the plane of the chip 1000 (compared to out of the plane, where chips are stacked), the scan range can be effectively set by the number of edge couplers 1030 and the span of the edge couplers 1030 along the facet 1004 (e.g., millimeters). When using the chip-stacking approach to 2D scanning, scan ranges out of the plane of the chip 1000 may be larger, e.g., 50-400 μm, and the larger scan range would result in actuation speeds more compatible with the slow axis.

The switch devices 1012 that route the beams within the photonic integrated circuit chip 1000 may include Mach-Zehnder interferometers with thermo-optic phase shifters or MEMS phase shifters. The waveguides 1020 may include cores 1022 made of silicon nitride (SiN) or aluminum oxide (Al₂O₃) with cladding 1024 made of SiO₂. The actuator(s) 1040 may be considered a general two-axis device made of many individual actuators (each moving one or more edge couplers) or a single actuator that moves the entire set of edge couplers on the chip facet. Along the axis of the array of edge couplers, the actuator movement should be greater than or equal to the pitch between edge couplers (to avoid gaps appearing between the FOV slices).

Switches 1012 integrated into the photonic integrated circuit chip 1000 could be used for one or more purposes. For example, the switches 1012 can amplitude modulate the beams, so the lasers 1020 emit continuous-wave beams at constant amplitudes, and the switching period is on the time scale of the pixel dwell time. The amplitude modulation/switch speed can be about 1 MHz to about 1 GHz, depending on frame rate and number of beams, and there can be three times as many switches 1012 as there are beams per color (for RGB displays). Switches 1012 can also perform line-by-line switching to increase the number of edge couplers 1030/actuators 1040 for a fixed number of intensity-modulated beams on the chip 1000 (e.g., number of directly modulated lasers 1010).

For line-by-line switching, the switching rate should be faster than the scan time for each line but not as fast as the intensity modulation for each pixel (e.g., about 100 kHz to about 10 MHz). For line-by-line switching, the number of inputs of the switches equals the number of modulated beams on the chip 1000, the number of outputs of the switches equals the numbers of edge couplers 1030; more switches 1012 can further increase the number of edge couplers 1030 and reduce the actuator range of motion. Switches 1012 can also perform switching between frames to address the edge couplers 1030 based on eye position at a rate faster than the frame rate (e.g., about 100 Hz to about 10 kHz). These different applications could have different architectures or an architecture that combines multiple functionalities.

Wavelength multiplexers 1022 on the photonic integrated circuit chip 1000 for red (R), green (G), and blue (B) light may be used to enable each edge coupler 1030 to emit RGB beams. Alternatively, separate closely spaced edge couplers 1030 may be used to independently emit R, G, and B beams. The on-chip actuators 1040 may rely on thermal expansion, electrostatic force, electromagnetic force, or the piezoelectric effect to move or scan the edge couplers 1030 in two dimensions. Alternatively, the on-chip actuators 1040 may move or scan the edge couplers 1030 and the beams in one direction (e.g., horizontally), and a scanning MEMS mirror (not shown) positioned in the beam path between the edge couplers 1030 and the optical combiner 110 may scan the beams in the orthogonal direction (e.g., vertically).

### On-Chip Switching and Movement of On-Chip Actuators

One consideration with on-chip actuators is how far they should move. In a display with reasonable performance, the optical emitters should cover areas comparable to conventional panel micro-displays (often about 5-12 mm along the diagonal). Optical switches can be used to reduce the amount of translation in the plane of the chip.

FIGS. 10D-10G show how the optical switches 1012 in the photonic integrated circuit chip 1000 of FIG. 10A can be used to reduce the translation ranges of the on-chip actuators 1040. FIG. 10D shows successive sub-frames of a multiplexing scheme in which by fast scanning is accomplished by vertical scanning of the actuators 1040 and slow scanning is accomplished with a combination of optical switching and horizontal scanning of the actuators 1040. FIG. 10E shows an example set of parameters for 1080p resolution for the multiplexing scheme of FIG. 10D. In FIG. 10E, the motion of the actuators is taken to be the only limit on the resolution. In practice, the mode-field diameter at the edge couplers (or beam size at the grating coupler surface) may also limit the resolution. Achieving 1080p resolution with the display size listed in FIG. 10E would involve approximately 2 m (or smaller) mode field diameters at the edge coupler facets. This also limits the minimum numerical aperture of the beams emitted by the edge couplers. Additional limitations to the resolution may arise from the collimation/relay optics and optical combiner.

The table in FIG. 10E assumes that each edge coupler 1030 is on a separate actuator 1040, but similar calculations may be performed for multiple waveguides on each actuator. The lateral translation range of the actuators 1030 is simply the display width at the edge coupler plane divided by the number of actuators 1030 per chip 1000. Similarly, the vertical translation range is the display height at the edge coupler plane divided by the number of chips 1000 stacked on top of each other. Compared to conventional laser scanning display, the fast axis frequency is scaled down by a factor of 1/(number of lasers per color per chip), the laser modulation frequency is scaled down by a factor of 1/(total number of lasers per color per eye), the slow axis frequency is scaled up by a factor of (number of actuators per chip/number of lasers per color per chip), and the switching frequency is equal to the slow axis frequency.

FIGS. 10F and 10G show an example of line switching for the 2D actuators 1040 in FIGS. 10A-10C. Estimating a field of view for this approach can be complicated because this depends on the photonic chip 1000, collimation/relay optics 1050, and optical combiner 110. In principle, if the waveguide emitters 1030 span areas comparable to current LCOS or OLED panel micro-displays, fields of view comparable to commercially available head-mounted displays based on this technology may be achieved (i.e., we can think of the photonic chip 1000 with 2D actuators 1040 as a panel display where the pixels laterally move to fill in gaps between them). Thus, the estimated field of view range is between about 20-60 degrees along the diagonal, with larger fields of view involving larger areas spanned by the waveguide emitters. A more practical range on the field of view is 30-50 degrees along the diagonal. In principle, with a large enough area, higher fields of view may also be possible.

The field of view of such a system depends on the input beam diameter to the optical combiner 110 and the collimation and relay optics 1050. Overall, with an appropriate choice of the display size (i.e., area spanned by the optical emitters), fields of view between about 20-50 degrees diagonal may be possible with millimeter-scale beam diameters at the input coupler of the optical combiner 110. The area of the display may be larger than shown in the tables in FIGS. 10E and 10G to achieve a >300 field of view, but the waveguide emitters could span a diagonal of about 10 mm or less.

One practical embodiment of the photonic chip 1000 has the actuators 1040 moving laterally and vertically with minimal axial motion (z-direction in FIG. 10D) and minimal angular motion. In many system configurations, axial motion may put the emitters 1030 out of focus of the collimation optics 1050 and angular motion may result in image distortion. However, some degree of angular motion and axial motion may be acceptable, depending on the design of collimation/relay optics and overall resolution of the system.

### Example On-Chip Actuators

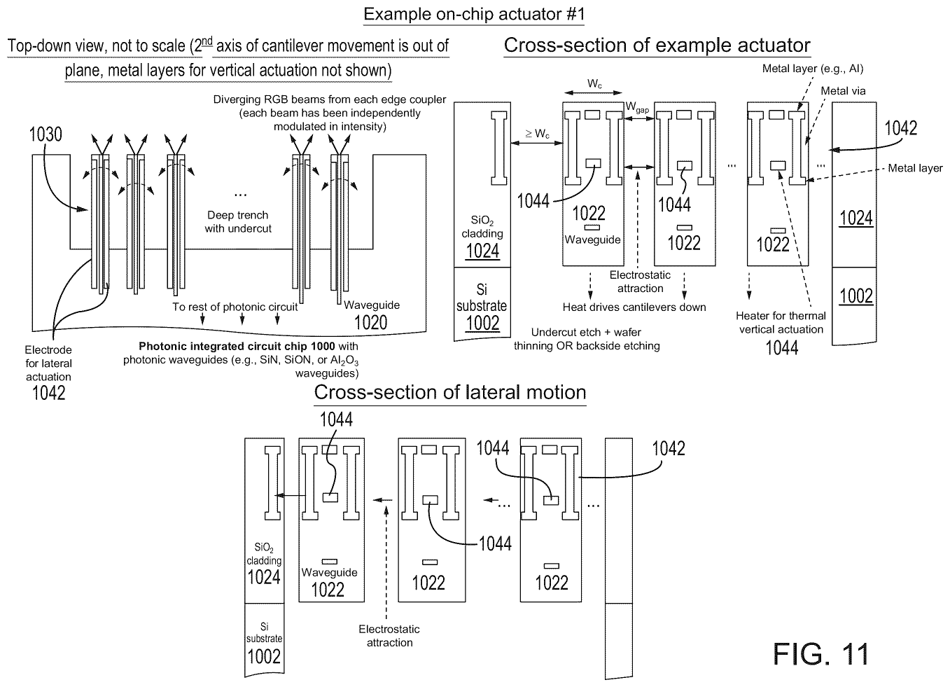

FIGS. 11-13, 14A, and 14B show different actuator arrangements for photonic integrated circuit chips (e.g., for the actuators 1040 in chip 1000 in FIGS. 10A-10C). Each of these photonic integrated circuit chips include edge couplers formed of cantilevers or pillars with waveguides running through them. These edge couplers have dimensions and pitches that depend, at least in part, on the waveguide material. Waveguides with SiN or Al₂O₃ waveguide cores and SiO₂ cladding typically have waveguide thicknesses of about 30-400 nm. The width of the edge coupler at the facet (for an inverse taper design) can be about 50-250 nm, depending on the waveguide thickness and the resolution of the fabrication process. For example, in the bi-layer edge coupler design shown in FIG. 6, the thin SiN layer used for the edge coupler has a thickness of about 75 nm and the edge coupler width at the facet is about 100-300 nm. Other material systems (e.g., SiON waveguide cores with SiO₂ claddings) may have different dimensions due to their lower refractive index (e.g., a larger thickness and wider width at the facet).

Each photonic integrated circuit chip includes two or more edge couplers (e.g., tens, hundreds, or thousands of edge couplers), with better performance for more edge couplers (since the FOV addressing is increasingly parallelized). Increasing the number of edge couplers also reduces the range of motion per actuator, i.e., the range of motion of the actuators to address the full FOV including the gaps between actuators/edge couplers. One limit on the number of edge couplers is the pitch between the waveguides at which optical crosstalk becomes unacceptable (a pitch of 10-20 μm is usually sufficient to avoid unacceptable optical crosstalk). Another consideration that affects the number of edge couplers is whether red, green, and blue light is multiplexed before the output edge couplers. Without any multiplexing, the chip includes one edge coupler per beam for each coupler. Multiplexing reduces the number of edge couplers, e.g., by a factor of three.

FIG. 11 shows different views of actuators 1040 in FIGS. 10A-10C. These combinations of edge couplers 1030 and actuators 1040 are cantilevers formed by etching the substrate 1002 of the photonic integrated circuit chip 1000. The substrate etching may be performed by undercut etching of the cantilevers followed by wafer thinning such that there is no substrate remaining beneath the cantilevers. Alternatively, patterned back-side etching of the substrate 1002 may be used to release the cantilevers. Complete removal of the substrate 1002 beneath each actuator 1040 eliminates or avoids gaps between FOV slices if several photonic integrated circuit chips 1000 are stacked on top of each other as described above and shown in FIG. 10C. These points regarding substrate etching apply to the overall approach and not just the example actuator 1040 in FIG. 11.

Each cantilever includes a waveguide core 1022 (e.g., made of SiN, SiON, or Al₂O₃) surrounded by cladding 1024 (e.g., SiO₂). Metal layers 1042 on, embedded in, and/or embedded in opposite sides of the cladding 1024 are connected to electrodes and are used for electrostatic actuation and thermal expansion. The metal layers 1042 (e.g., aluminum layers) should have a large thermal expansion coefficient difference with the substrate material, and their thickness should be a significant fraction of the overall cantilever thickness.

Each cantilever also includes a heater layer 1044 in thermal and electrical contact with the metal layers 1042. The heater layer 1044 can be a thinner film with higher resistance (e.g., titanium nitride, doped silicon, or a thin layer of titanium or platinum). Thermal actuation can be achieved by running current through the metal layers 1042 to the heater layers 1044 in the cantilevers, causing the heater layers 1044 to heat up; the differing thermal expansion coefficients of the metal layers 1042 and the SiO₂ (cladding 1024) in the cantilever causes the cantilever to bend with heating. (This type of cantilever structure is also referred to as a thermal bimorph actuator or structure.) Thermal actuation is used for translation of the cantilevers along one axis (e.g., the vertical axis) and electrostatic actuation is used for translation of the cantilevers along the orthogonal axis (e.g., the horizontal axis).

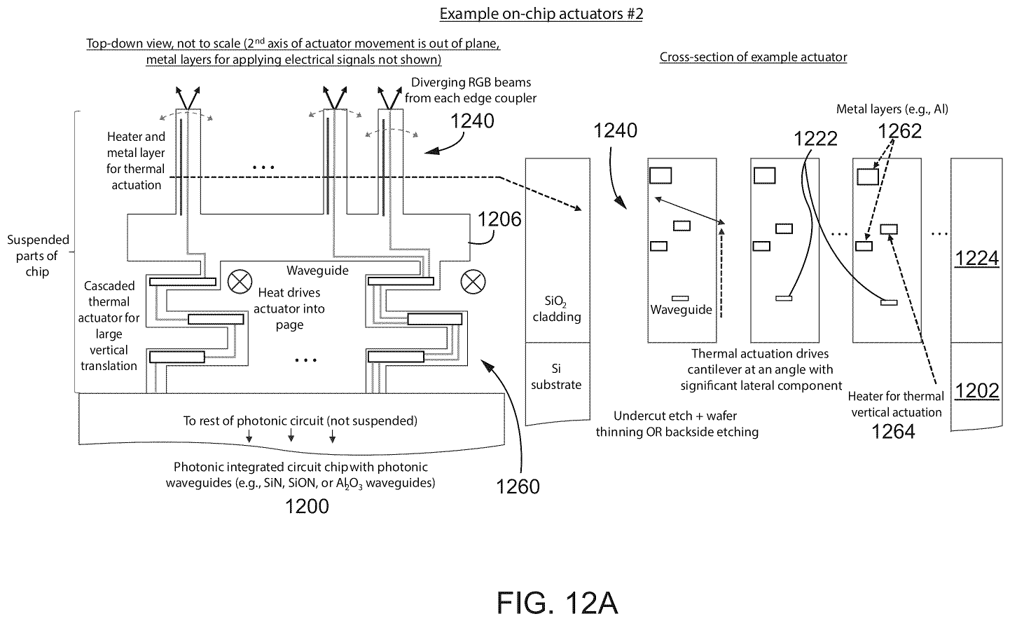

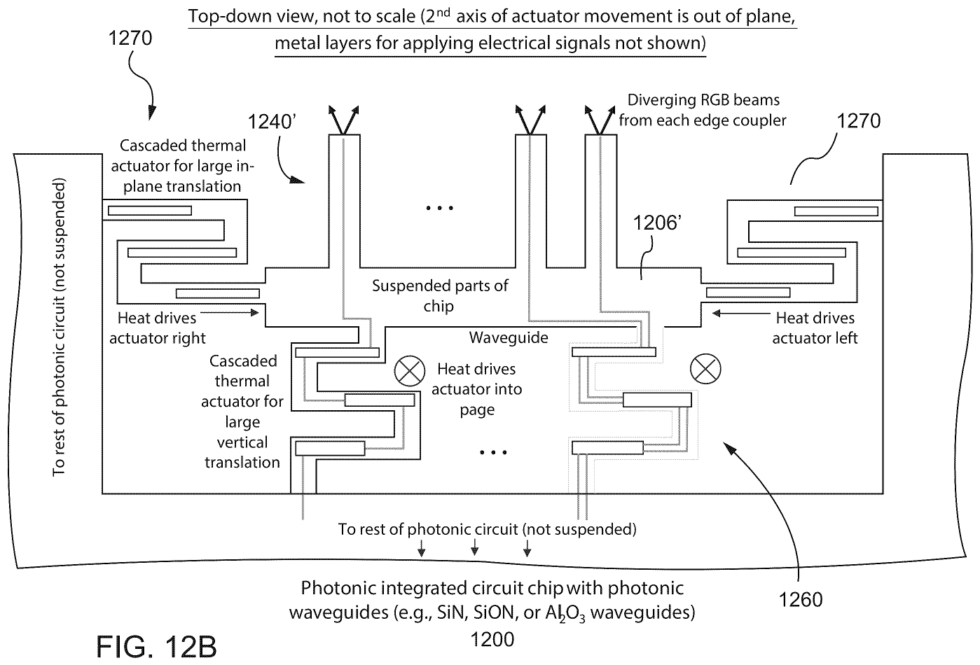

FIG. 12A shows a photonic integrated circuit chip 1200 with cantilevered actuators 1240 like those in FIG. 11 extending from a platform 1206 that is suspended from the rest of a photonic integrated circuit chip 1200 via a set of cascaded thermal bimorph actuators 1260. The cascaded thermal bimorph actuators 1260 have waveguide cores 1222 that are surrounded by cladding 1224 and that guide light from the rest of the photonic integrated circuit chip 1200 to the cantilevered actuators 1240. They also include metal layers 1262 that are electrically coupled to a current source (not shown) and act as resistive heaters. The metal layers 1262 have two functions: (1) they are electrically connected to the heaters for applying current, and (2) they expand with heating (from the heater layers) for the thermal actuation.

In this example, the cascaded thermal bimorph actuators 1260 are used for large translation along the vertical axis and thermal actuation of the cantilevers 1240 is used for horizontal translation. For displays, typically the field of view along the horizontal axis of the viewer is larger than the vertical axis, so the cascaded thermal bimorph actuators 1260 can also be used for horizontal deflection if they produce a larger deflection than the cantilevered actuators 1240 (in a head-mounted display, the actuator with larger deflection is usually oriented to scan along the horizontal axis).

FIG. 12B shows an actuator configuration with cascaded cantilever devices 1260 used for vertical translation and additional cascaded cantilever devices 1270 used for lateral translation of edge couplers 1240′ extending from a platform 1206′. The cascaded cantilever devices 1260, 1270 may include sections with heaters and metal that can bend, followed by straight sections (with no heater or metal, and possibly additional material to increase the stiffness such as some remaining thickness of the silicon wafer substrate). By engineering the lengths of these sections, perfectly vertical motion of the end of the cascaded cantilever may be possible (i.e., without angular or lateral motion). Similarly, these lengths may be engineered to achieve perfectly lateral motion (i.e., without angular or vertical motion, and without in-plane motion along the orthogonal axis to the translation axis).

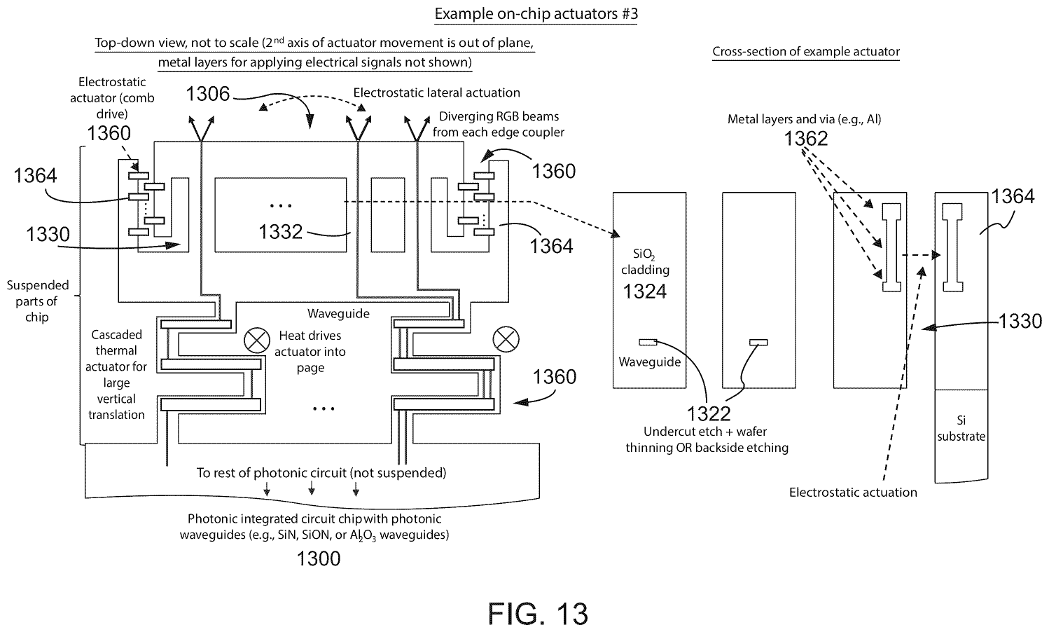

FIG. 13 shows a photonic integrated circuit chip 1300 with electrostatic comb drives 1370 for horizontal actuation. The electrostatic comb drives 1370 are on opposite sides of a waveguide structure 1330 with waveguide cores 1322 running through cladding 1324 in pillars 1332 that extend from a platform 1306 supported by cascaded thermal bimorph actuators 1360 as in FIG. 12A. Structures 1364 extending parallel to the pillars 1330 from the platform 1306 and the waveguide structure 1330 support interleaved metallic tines 1362 of the electrostatic comb drives 1360. Except for the pillars 1330, the waveguide structure 1306 is released from the platform 1306 so that it can bend laterally (horizontally) with respect to the platform 1306 when the electrostatic comb drives 1360 are actuated.

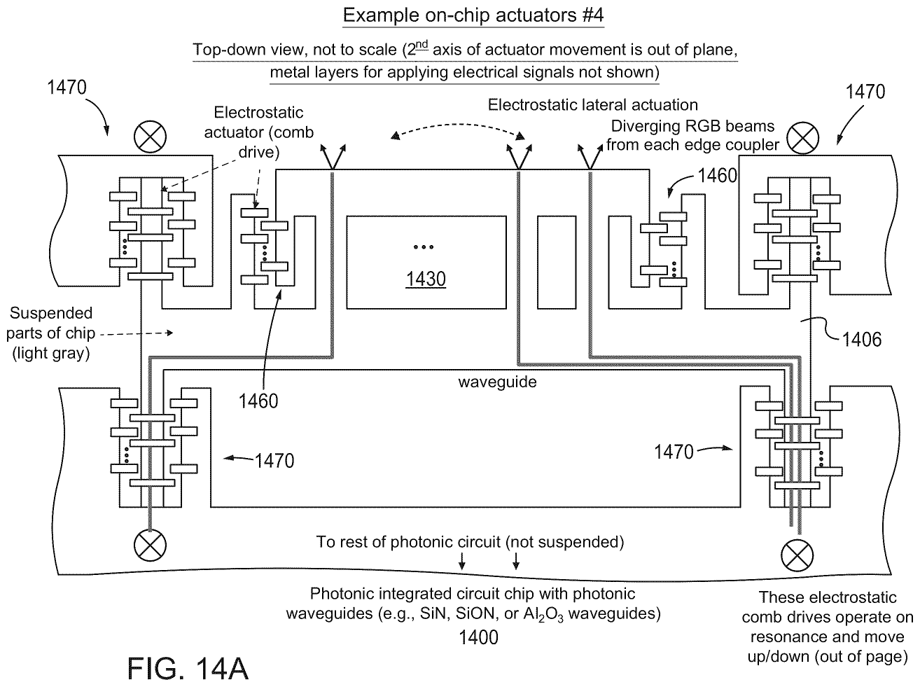

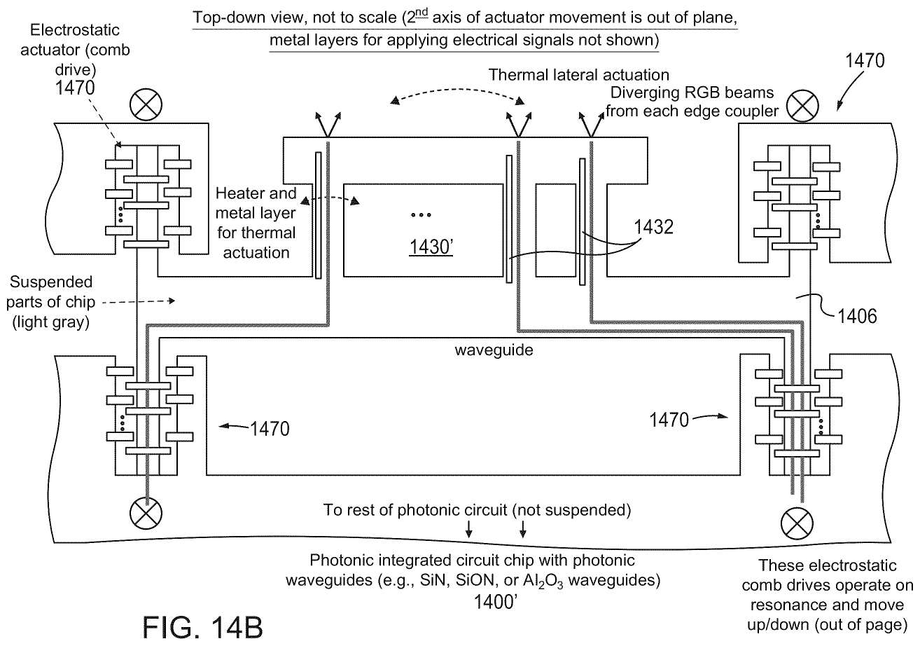

FIGS. 14A and 14B show photonic integrated circuit chips 1400, 1400′ where electrostatic comb drives are used for vertical actuation. The chip 1400 in FIG. 14A includes a first set of electrostatic comb drives 1460 on opposite sides of a waveguide structure 1430 with waveguide cores running through pillars that extend from a platform 1406 that is cantilevered from the chip 1400. Actuating the first set of electrostatic comb drives 1460 moves the pillars laterally (back and forth in the plane of the page). A second set of electrostatic comb drives 1470 moves the entire platform 1406 into and out of the plane of the page. Similarly, the chip 1400′ in FIG. 14B includes electrostatic comb drives 1470 configured to move an entire platform 1406′ into and out of the plane of the page. This platform 1406′ supports a waveguide structure 1430′ with waveguide cores and thermal bimorph actuators 1432 for in-plane actuation. Put differently, in both FIGS. 14A and 14B, electrostatic comb drives 1470 support waveguide structures that include separate actuators for horizontal actuation (separate electrostatic comb drives 1460 in FIG. 14A and thermal bimorph actuators 1432 in FIG. 14B). The electrodes of the vertically actuating electrostatic comb drives 1470 in FIGS. 14A and 14B may all be in the same plane and driven in resonant mode (wherein small asymmetries between the comb drives enable the oscillation to build up).

The light-emitting waveguides in FIGS. 11-14 can also be on a single MEMS-actuated platform (instead of singular cantilevers) that can tip and tilt to realize beam scanning in two axes. Alternatively, light-emitting waveguides that move along one axis can illuminate a separate moving mirror (e.g., a MEMS-actuated mirror) that scans the beams along the orthogonal axis to realize two-dimensional beam scanning.

Other suitable actuators include electromagnetic and piezoelectric actuators. Electromagnetic actuation involves arranging the on-chip wiring into a coil and applying an external magnetic field (typically by packaging the chip with a small external magnet). In a piezoelectric actuator, a piezoelectric material (e.g., AlN, ScAlN, or PZT) is on the chip or on a common substrate with the chip. The piezoelectric material is then driven with an alternating current (AC) electrical signal and the mechanical vibration can excite a mechanical resonance of the actuator(s).

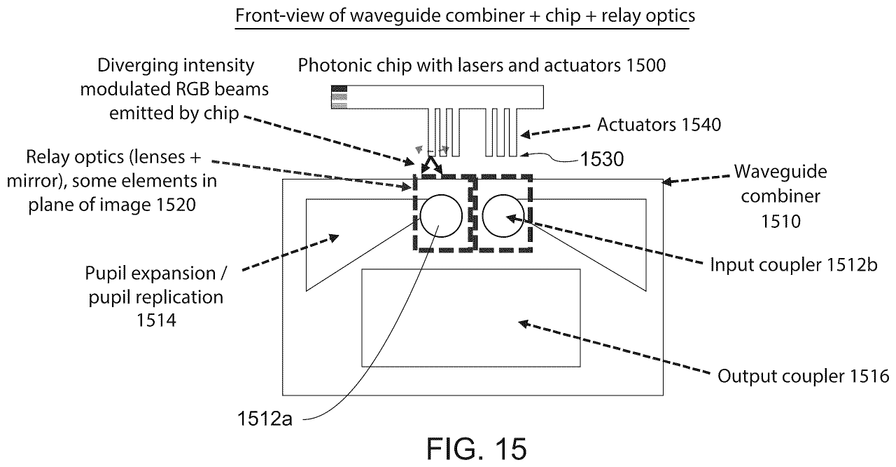

FIG. 15 shows a photonic integrated circuit chip 1500 with multiple arrays of edge couplers 1530 with actuators 1540, each coupled into a separate input coupler 1512a and 1512b of a waveguide combiner 1510. For waveguide combiners based on total internal reflection (TIR), this can allow doubling of the FOV supported by the waveguide combiner 1510. Briefly, the edge couplers 1530 may be formed by, for example, inverse tapers (i.e., reduced waveguide width at the facet) or bi-layer edge couplers as shown in FIG. 6.

The photonic integrated circuit chip 1500 in FIG. 15 can also be configured to have multiple sets of actuators 1540 positioned millimeters or centimeters away from each other (possibly at the expense of longer waveguides which increases optical loss). These sets of actuators 1540 can be coupled into multiple different input couplers 1512a, 1512b of an optical combiner 1510 (or multiple different input couplers, each corresponding to a different waveguide combiner arranged in a stack) via relay optics 1520.

In one practical example, the two input couplers 1512a, 1512b may send light in opposite directions in the waveguide combiner 1510. Since optical combiners based on total internal reflection limit the field of view to angles which undergo total internal reflection, such an approach can be used to, in principle, double the field of view along one axis. Here, the left input coupler 1512a sends light to the left and the right input coupler 1512b sends light to the right in the waveguide, with the field of view for each path being limited by the total internal reflection limit. The pupil expansion/replication regions 1514 direct the light to an output coupler 1516, and the overall output of the output coupler 1516 supports twice the field of view along a single axis as a conventional waveguide combiner 1510.

In addition, grating couplers or out-of-plane edge couplers may be used to emit beams vertically from the surface of the actuator rather than in-plane edge couplers.

Finally, rather than a Si wafer with SiO₂ cladding, a silicon-on-insulator (SOI) wafer may be used for any of the photonic integrated circuit chips described herein. In such an implementation, the starting wafer has a Si layer (e.g., 10-100 μm thick or 100-1000 nm thick) above a buried SiO₂ layer, all on top of a thick Si substrate. The photonic waveguide and metal layers are deposited on top of the SOI wafer. The buried SiO₂ layer or the Si substrate can be undercut etched to release actuator structures formed by the Si layer, photonic, and metal layers.

Backside etching may also be used to release the actuator structures, with a large cavity formed under the actuators for large vertical translations (with the buried SiO₂ serving as an etch stop for the Si substrate etch). The additional Si layer of the SOI wafer can be used as an electrode for comb drives or other electrostatic actuators. Advantages of using a SOI wafer include comb drives with electrodes that are thicker and therefore have higher resonance frequencies and are more robust. An additional advantage is that thicker electrodes may fill a larger percentage of the actuator thickness, reducing the drive voltages. Electrostatic (comb) actuators can be formed by metal layers (as in FIGS. 13, 14A, and 14B) and by the Si layer (doped for reasonable conductivity) of an SOI wafer.

Displays with On- and Off-Chip Actuators

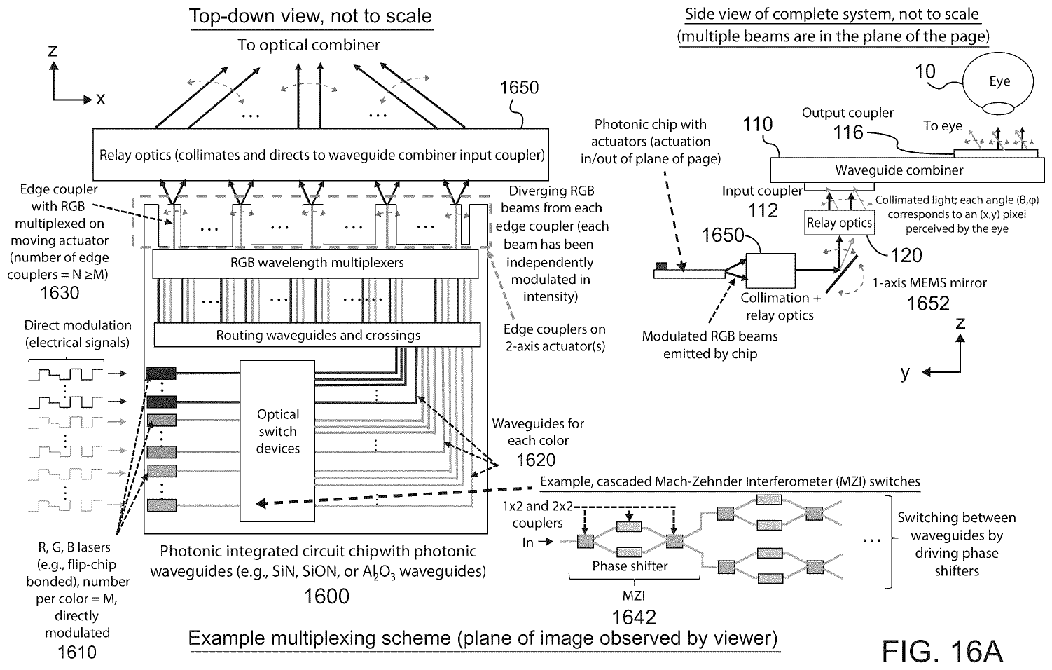

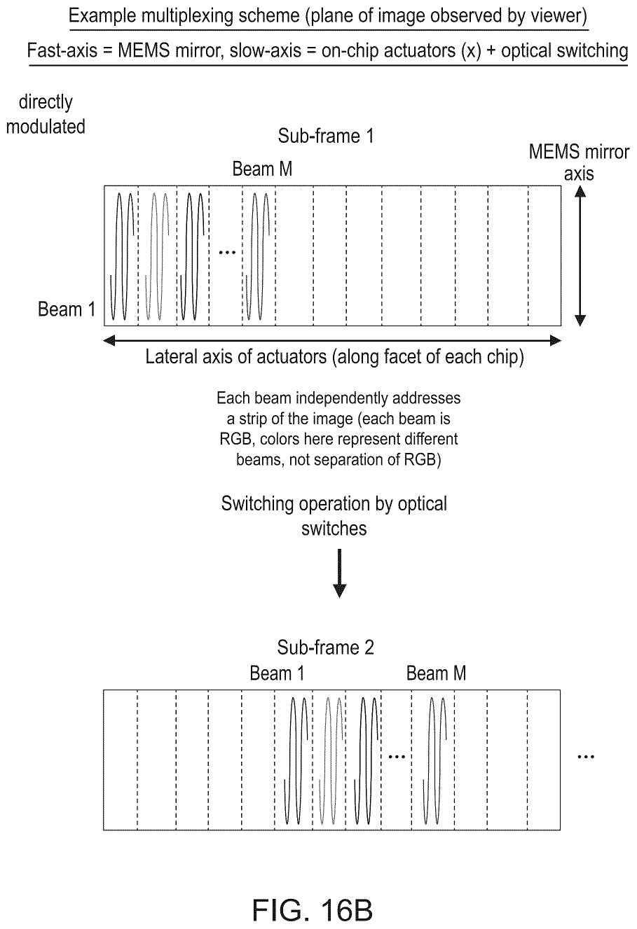

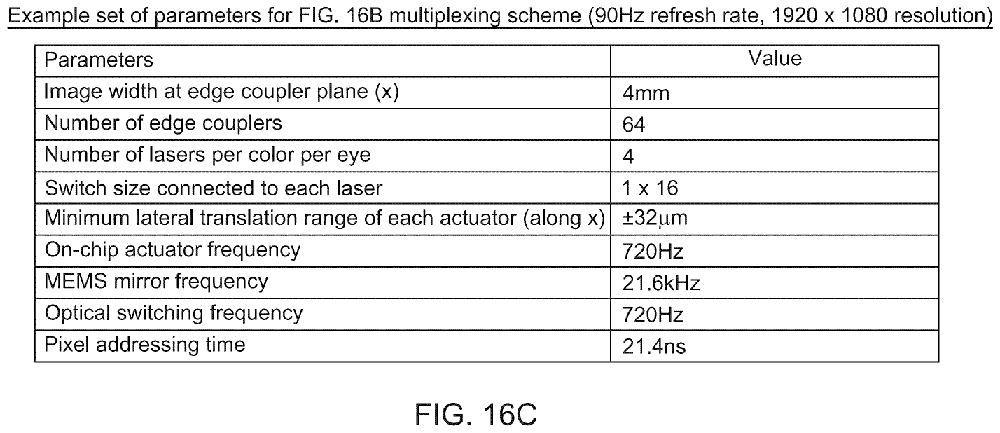

FIGS. 16A-16C show a photonic integrated circuit chip 1600 that uses both on-chip actuators 1630 and a separate one-axis scanning MEMS mirror 1652 to alleviate some of the technical challenges with achieving large areas of coverage for waveguide emitters. Achieving a high density of actuators and/or a large translation range and/or high actuation frequencies is generally less complicated with 1D actuators on a single chip compared to 2D actuators with a number of stacked chips. FIGS. 16B and 16C show a multiplexing scheme and multiplexing parameters, respectively, for the photonic integrated circuit chip 1600 of FIG. 16A.

Like the chips disclosed above, the photonic integrated circuit chip 1600 includes lasers 1610 that emit red, green, and blue light into on-chip waveguides 1620 via on-chip optical switches 1612, which may be implemented as cascaded Mach-Zehnder interferometers 1642 as shown at lower right. The waveguides 1620 guide the light to on-chip multiplexers 1640, which multiplex red, green, and blue light on the cantilevered edge couplers 1630 with integrated actuators. The actuated, cantilevered edge couplers 1630 can scan light emitted into free space in one direction (e.g., vertically or horizontally). Relay optics 1650 collimate and direct the free-space beams to the MEMS mirror 1652, which scans the beams in a different (e.g., orthogonal) direction (e.g., horizontally or vertically). More relay optics 120 couple the scanning, free-space beams into the optical combiner 110.

### Piezoelectric Actuation

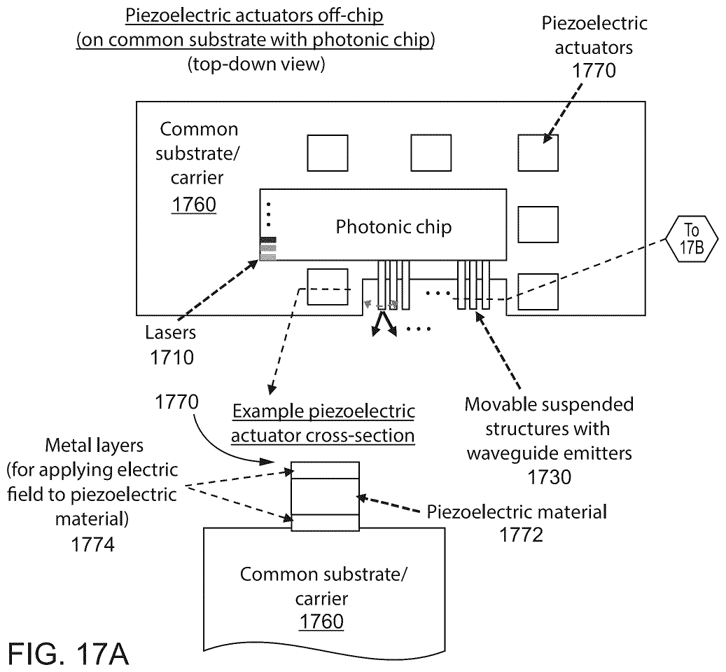

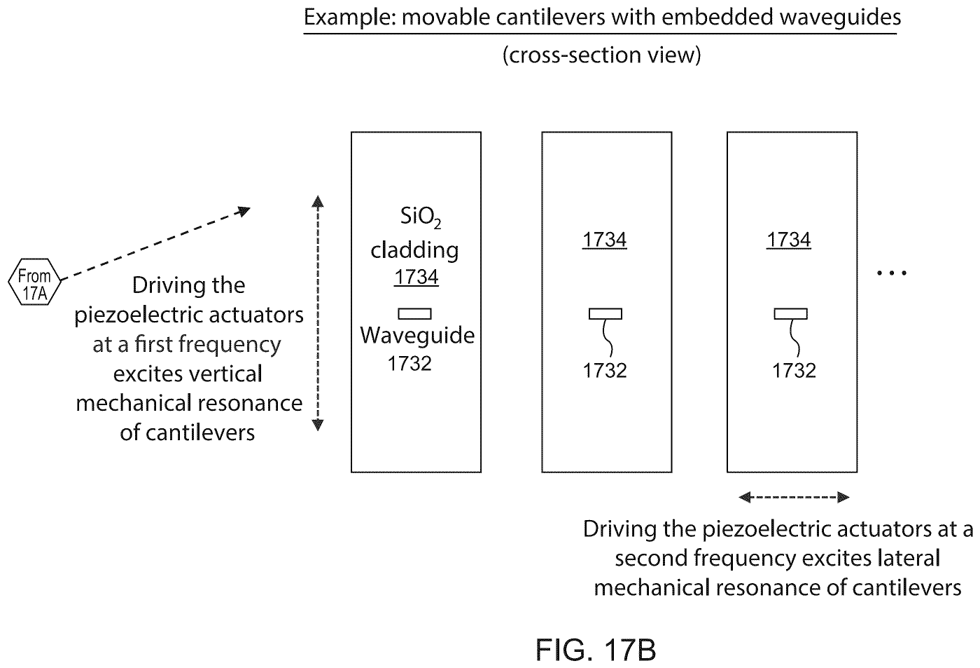

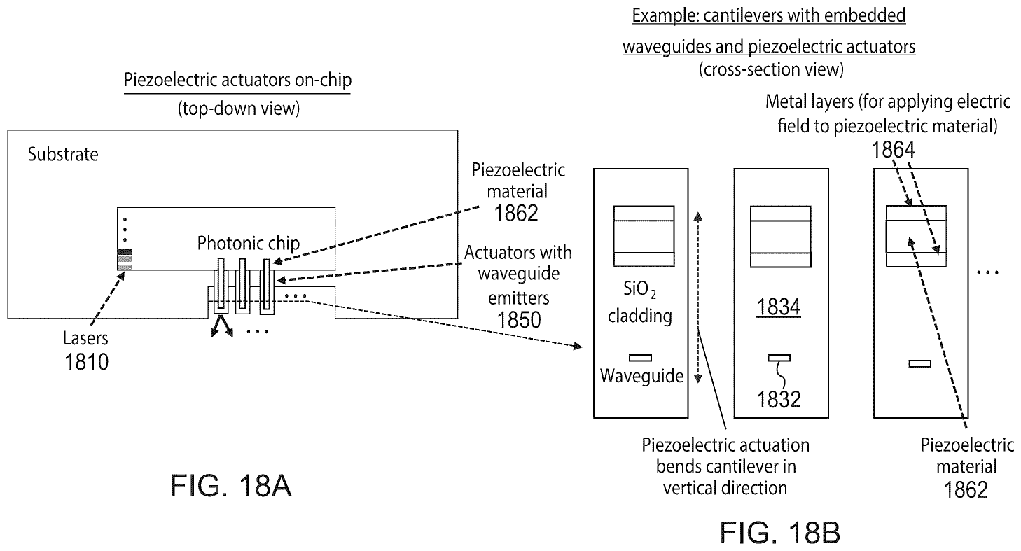

FIGS. 17A, 17B, 18A, and 18B show photonic integrated circuit chips 1700, 1800 that employ piezoelectric actuation. In FIGS. 17A and 17B, off-chip piezoelectric actuators 1770 on a common substrate 1760 with the photonic chip 1700 can be used to excite mechanical resonances of suspended structures 1730 with embedded waveguides (e.g., cantilevers with edge couplers). These waveguides comprise waveguide cores 1732 surrounded by dielectric cladding 1734 and emit red, green, and blue light produced by lasers 1710 integrated with the photonic chip 1700. The off-chip piezoelectric actuators 1770 that scan the emitted light comprise piezoelectric material 1772 sandwiched between metal layers (electrodes) 1774 that drive the actuation. The piezoelectric actuators 1770 can be driven at one or more resonance frequencies of the on-chip suspended structures 1730 and shake the common substrate and the photonic chip 1700 to excite the resonance(s), moving the waveguide emitters along one or more axes. The piezoelectric actuators 1770 shake the photonic chip 1700, slightly shaking the suspended structures 1730 (cantilevers). If this mechanical perturbation is periodic and aligned in both frequency and the axis of movement to a mechanical resonance, then the perturbation excites the mechanical resonance. The suspended structures 1730 (cantilevers) have up/down (out-of-plane) and lateral resonances that depend on their dimensions and material composition.

FIGS. 18A and 18B show a photonic integrated circuit chip 1800 with integrated piezoelectric actuators. In this chip 1800, integrated lasers 1810 emit light that is guided by integrated waveguides (not shown) to cantilevered actuators with waveguide emitters 1830. Each cantilever includes a waveguide core 1832, piezoelectric material 1862, and metal layers (electrodes) 1864 on opposite sides of the piezoelectric material 1862 embedded in cladding (e.g., SiO₂ cladding) 1834. These configurations may operate on a mechanical resonance or in quasi-static mode (e.g., the suspended/cantilevered structures 1830 can be bent depending on the electric field applied to the piezoelectric material 1862 with the metal layers 1864).

Photonic Integrated Circuit Chips with Movable On-Chip Plates

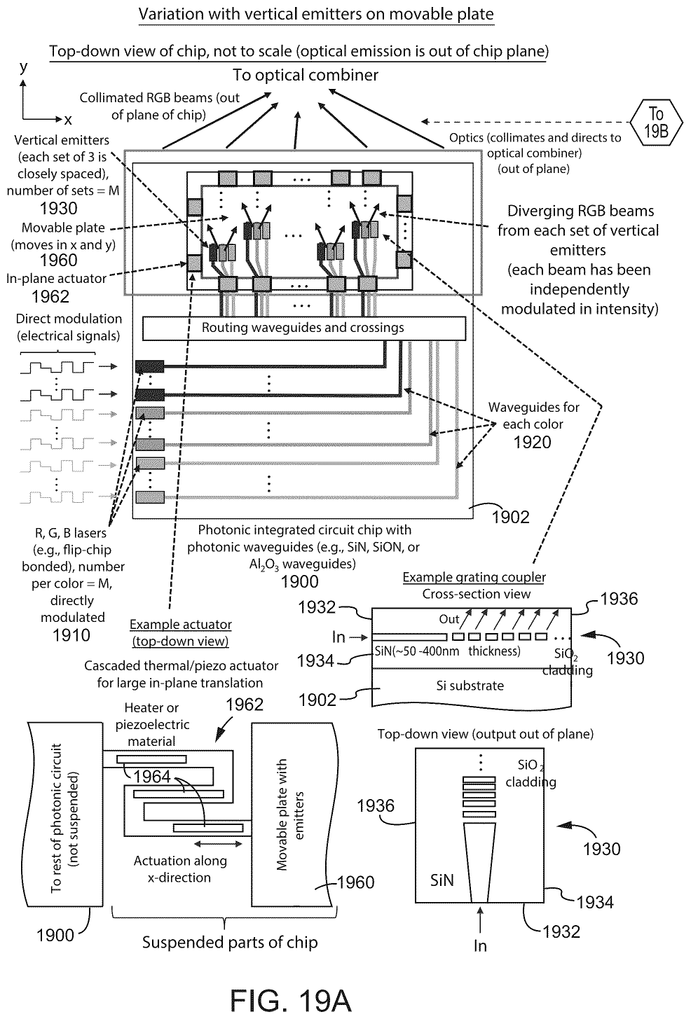

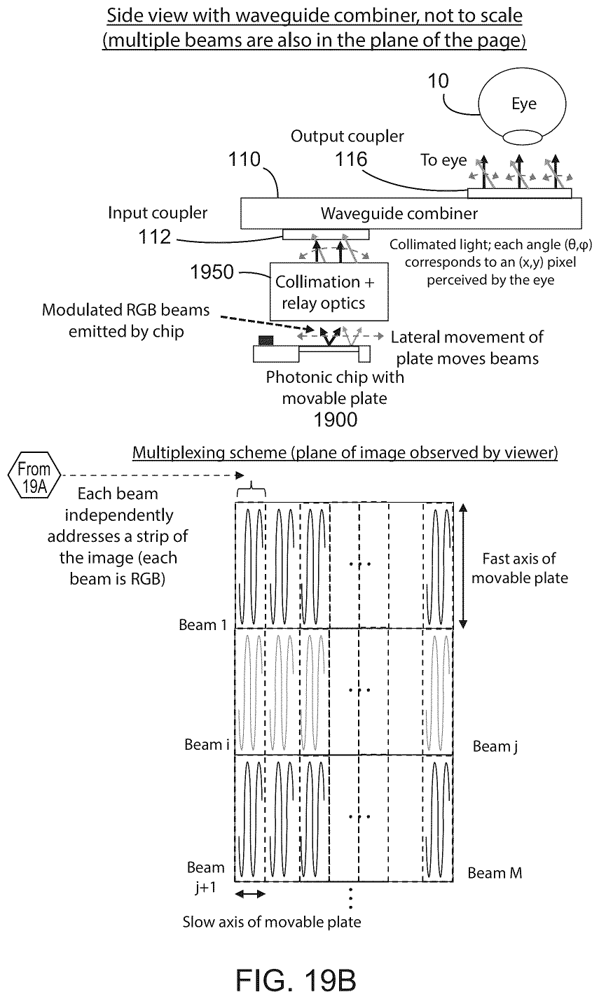

FIGS. 19-23 show photonic integrated circuit chips, each of which includes a movable plate with embedded waveguide emitters. FIGS. 19A and 19B shows a photonic integrated circuit chip 1900 with waveguides 1920 that guide light from lasers 1910 to vertical emitters 1930 on a movable plate 1960. Each vertical emitter 1930 includes a grating 1936 formed in a waveguide core 1932 surrounded by cladding 1934 on a substrate 1902. The movable plate 1960 is suspended from the photonic integrated circuit chip 1900 by cascaded on-chip actuators 1960, each of which includes one or more heaters or sections of piezoelectric material 1962. Driving the actuators 1960 moves the movable plate 1960 and the vertical emitters 1930 integrated with the movable plate 1960—laterally in one or two dimensions, depending on which actuators 1960 are being driven. Relay optics 1950 collimate the emitted beams and couple them into the waveguide combiner 110 as shown at upper right.

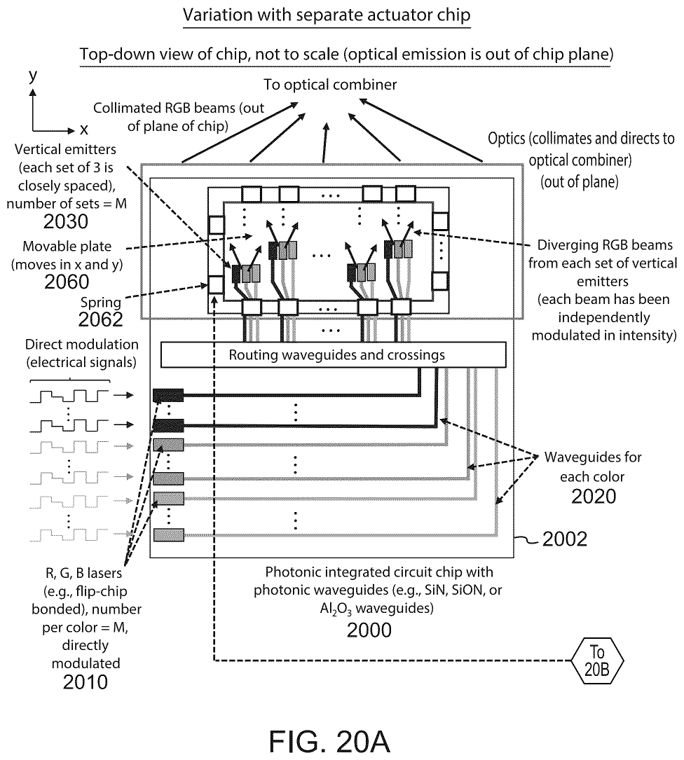

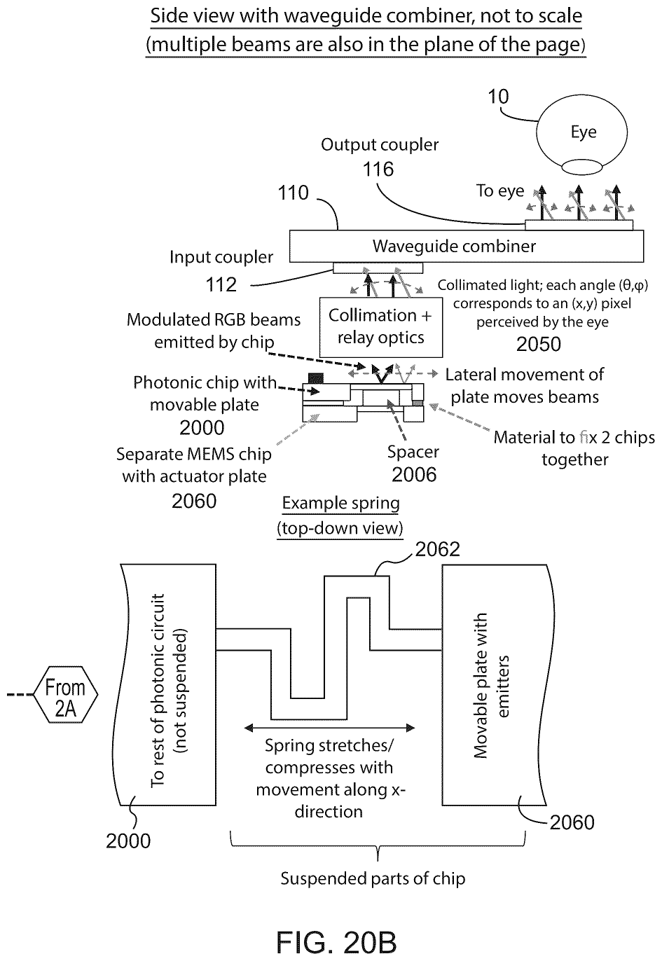

FIG. 20 shows a photonic integrated circuit chip 2000 with a movable plate 2060 suspended from a substrate 2002 by on-chip springs 2062. An off-chip actuator (e.g., a MEMS actuator) 2066 connected to the movable plate 2060 with a spacer 2006 moves the movable plate 2060 back and forth in one or two dimensions, depending on the actuation. Vertical emitters 2030 on the movable plate 2060 emit light guided by waveguides 2020 from on-chip lasers 2010 into free space.

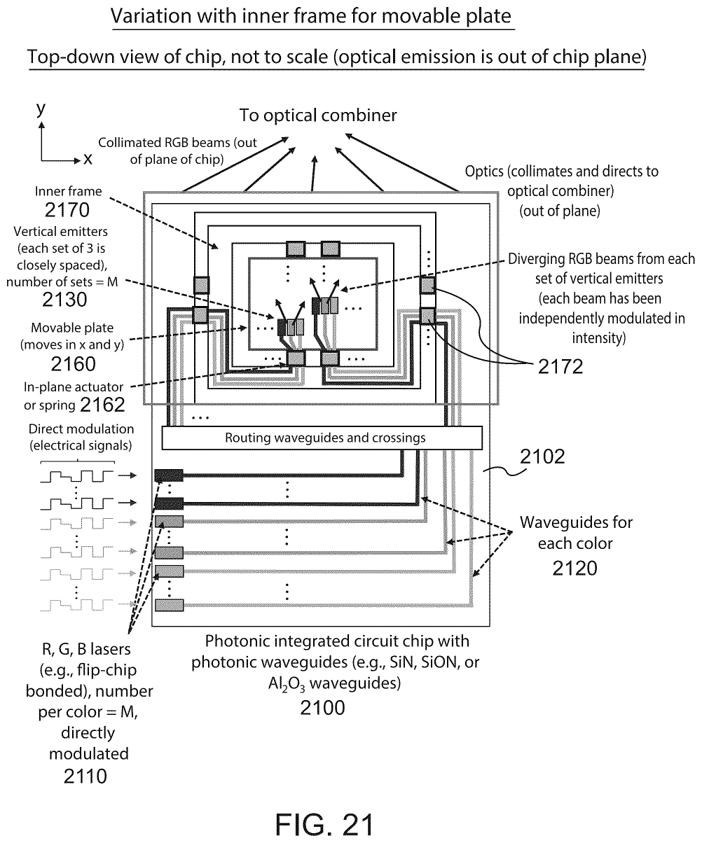

FIG. 21 shows a photonic integrated circuit chip 2100 with a movable plate 2160 suspended from an inner frame 2170 by in-plane actuators 2162 which itself is suspended from the substrate 2102 of the photonic integrated circuit chip 2100 by another set of in-plane actuators 2172. Integrated waveguides 2120 couple light from on-chip lasers 2110 to vertical emitters 2130 on the movable plate 2160 via the inner frame 2170. Each set of actuators 2162, 2172 moves the movable plate 2160 (and the vertical emitters 2130) in a different direction. The inner frame 2170 prevents movement along one axis from deforming the springs/actuators 2162/2172 along the other axis.

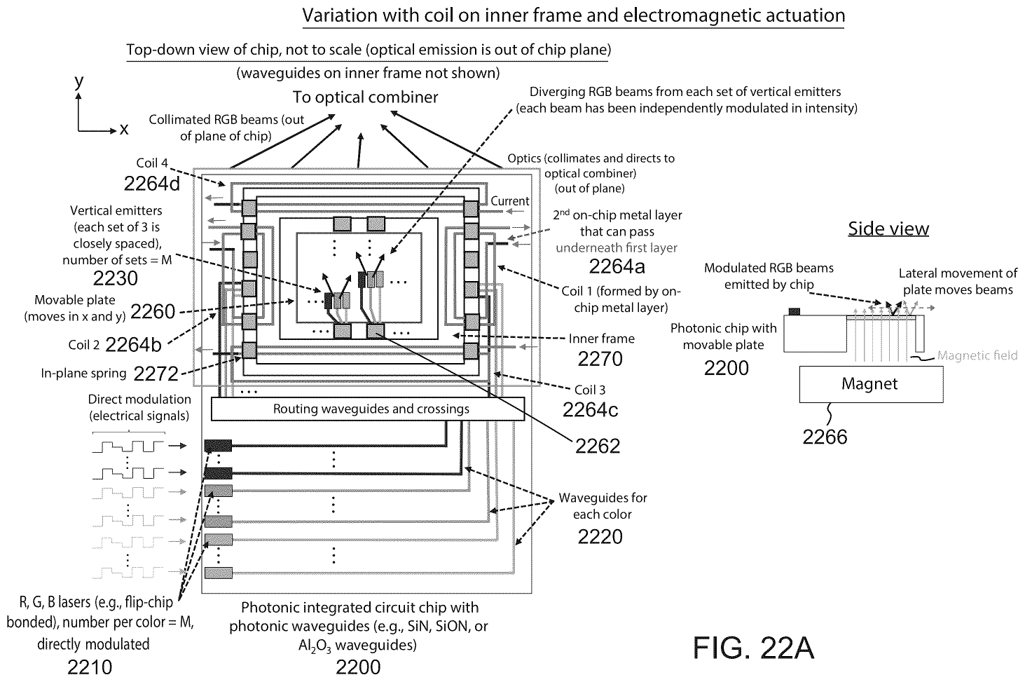

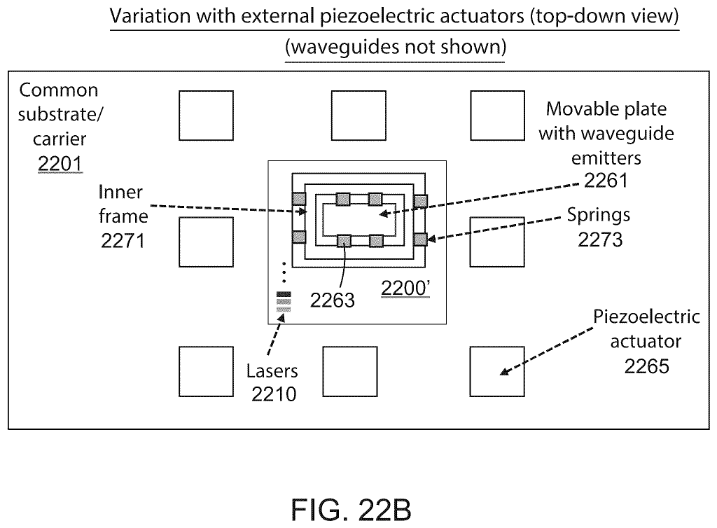

FIG. 22A shows an electromagnetic actuated photonic integrated circuit chip 2200 with a movable plate 2260 suspended from an inner frame 2270 by in-plane springs 2262 which itself is suspended from the substrate by more in-plane springs 2272. Again, integrated waveguides 2220 couple light from on-chip lasers 2210 to vertical emitters 2230 on the movable plate 2260 via the inner frame 2270. Running current through coils 2264a-2264d arranged around the outer edge of the inner frame 2270 applies force to the inner frame in the presence of a properly oriented magnetic field (i.e., supplied by a permanent magnet 2266 packaged with the photonic chip 2200 as shown at upper right). Coils 2264a and 2264b can translate the movable plate 2260 along the x-direction, and coils 2264c and 2264d can excite a mechanical resonance of the movable plate 2260 and springs 2262 for movement along the y-direction.

FIG. 22B shows a photonic integrated circuit chip 2200′ with piezoelectric actuation. The photonic integrated circuit chip 2200′ is on a carrier substrate 2201 and includes a movable plate 2261 on an inner frame 2271, both of which are suspended by in-plane springs 2263, 2273 and can move with respect to the photonic integrated circuit chip 2200′ and carrier substrate 2201. Piezoelectric actuators 2265 driven at resonance can move the movable plate 2261 in one direction (e.g., the y direction) and the movable plate 2261 and inner frame 2271 together in the orthogonal direction (e.g., the x direction). More specifically, the piezoelectric actuators 2265 shake the photonic chip 2200′, slightly shaking the inner frame 2271 and movable plate 2261. If this mechanical perturbation is periodic and aligned in both frequency and the axis of movement of a mechanical resonance, then the perturbation should excite the mechanical resonance. The movable plate 2261 and inner frame together 2271 have mechanical resonances determined by their dimensions and material compositions (in addition to those of the springs 2273 connecting the inner frame 2271 to the substrate 2201). Similarly, the movable plate 2261 has mechanical resonances determined by its dimensions and material composition (in addition to those of the springs 2263 connecting the movable plate 2261 to the inner frame 2271). In the case of the movable plate resonance, the mechanical perturbations are transmitted to the plate via the outer springs 2263 and inner frame 2271.

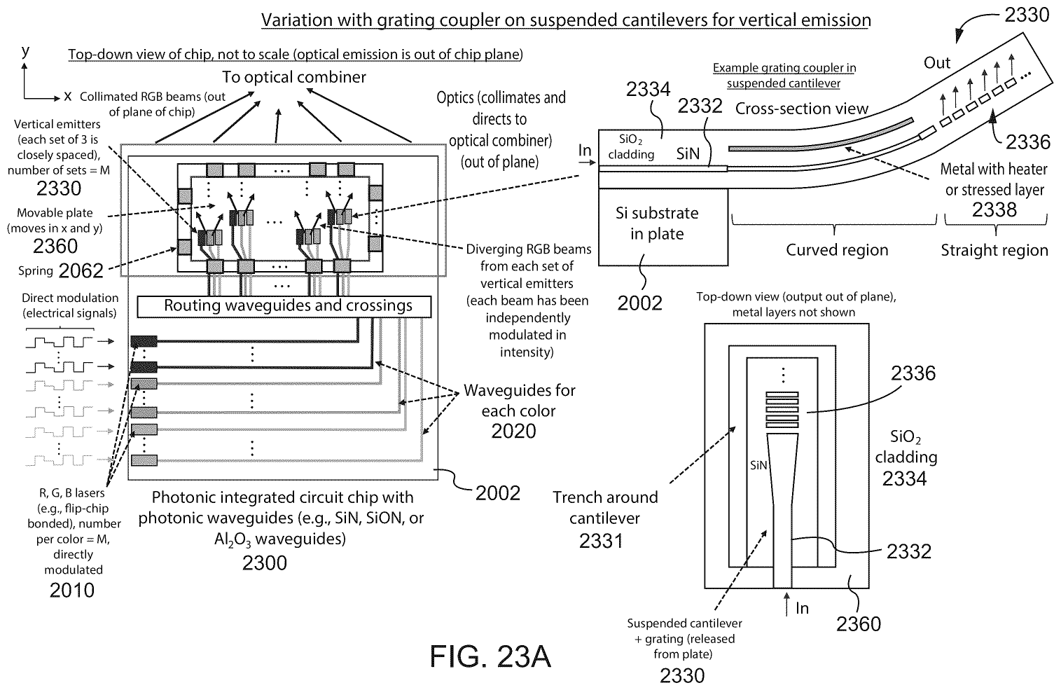

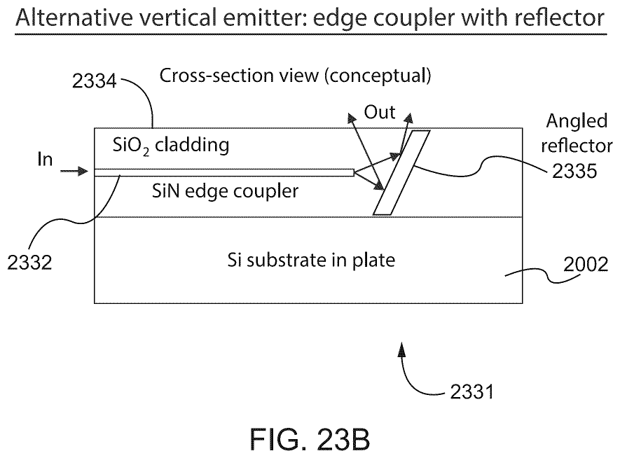

FIGS. 23A and 23B show details of different vertical emitters 2330, 2331 suitable for use in a photonic integrated circuit chip 2300 with (or without) a movable plate 2360 like the photonic integrated circuit chip 2000 shown in FIG. 20. In FIG. 23A, the vertical emitter 2330 includes a grating coupler 2336 on a suspended cantilever. The cantilever is partially supported by the substrate 2002 of the photonic integrated circuit chip 2300. It includes a waveguide core 2332 that is embedded in a cladding 2334 and terminates in the grating coupler 2336. The vertical emitter 2330 also includes a metal layer 2238 that can be heated or a layer with significant built-in stress to bend the cantilever; typically, grating couplers 2336 emit light at an angle relative to the normal of the photonic chip 2300, so bending the cantilever angles the gratings 2336 for vertical emission.

FIG. 23B show an alternative vertical coupler 2331 suitable for use in photonic integrated circuit chips. This vertical coupler 2331 includes an angled reflector 2335 to reflect light guided through the waveguide core 2332 out of the photonic integrated circuit chip. The angled reflector 2335 can be angled to reflect light out of the photonic integrated circuit chip perpendicular to the surface of the photonic integrated circuit chip or at a different angle with respect to the surface of the photonic integrated circuit chip.

### Coupling Lasers to Photonic Integrated Circuit Chips

In most of the photonic integrated chips described above, flip-chip bonding is mentioned as a method of coupling laser chips to the photonic integrated circuit chip.

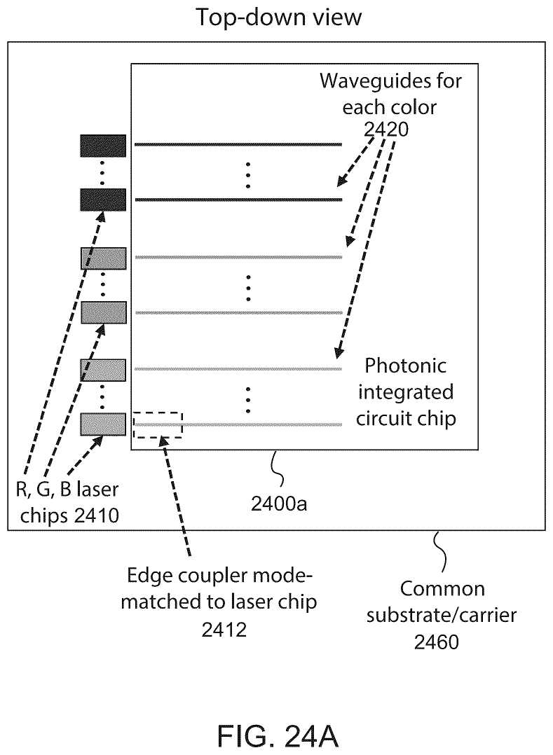

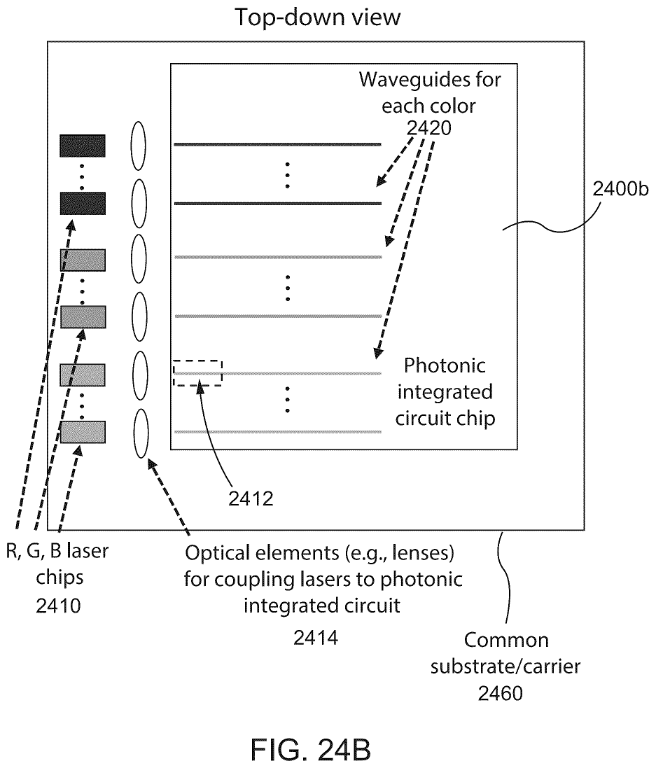

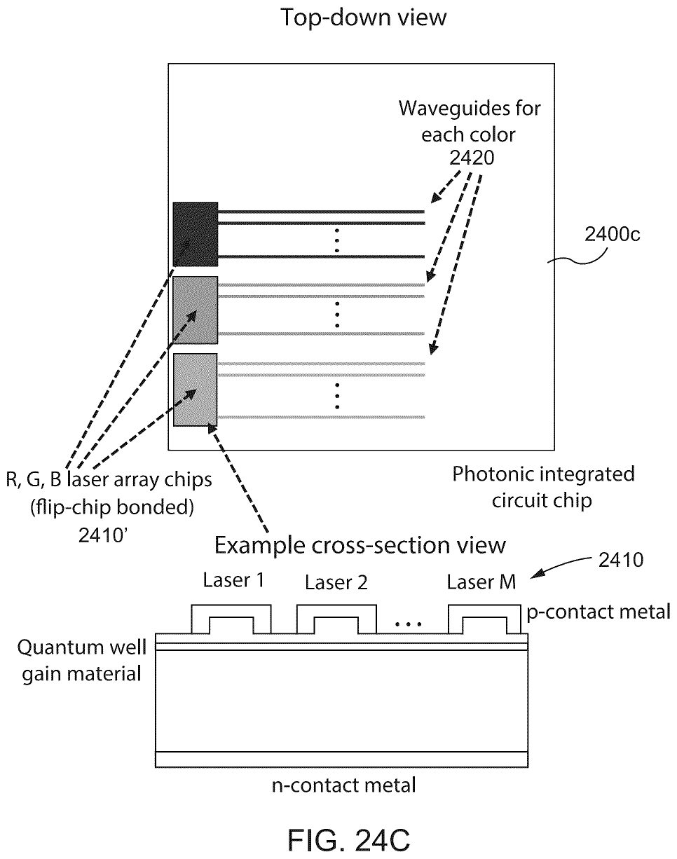

FIGS. 24A-24C illustrate other ways of coupling laser chips to the photonic integrated circuit chip. In FIG. 24A, laser chips 2410 are aligned to edge couplers 2412 on a photonic chip 2400a, and the laser chips 2410 and photonic chip 2400a are attached to a common substrate/carrier 2460. The laser chips 2410 may be attached to the common substrate/carrier 2460 face-up or flip-chip bonded. In FIG. 24B, the laser chips 2410 are coupled to edge couplers 2412 on a photonic chip 2400b through small optics 2414 (e.g., lenses). The optics 2414, laser chips 2410, and photonic chip 2400b are all attached to the common substrate/carrier 2460. FIG. 24C shows a photonic chip 2400c with integrated laser array chips 2410′. Each laser array chip 2410′ includes a set of individual lasers (with a lithographically defined pitch), which can help alleviate packaging challenges associated with aligning many laser chips to the photonic integrated circuit chip. In butt-coupling approaches (e.g., in FIGS. 24A and 24C and with flip-chip bonding in general), efficient optical coupling involves matching the optical waveguide mode of each edge coupler of the photonic chip to the waveguide mode of the corresponding laser chip.

### Waveguide Emitters on Tilt Plates

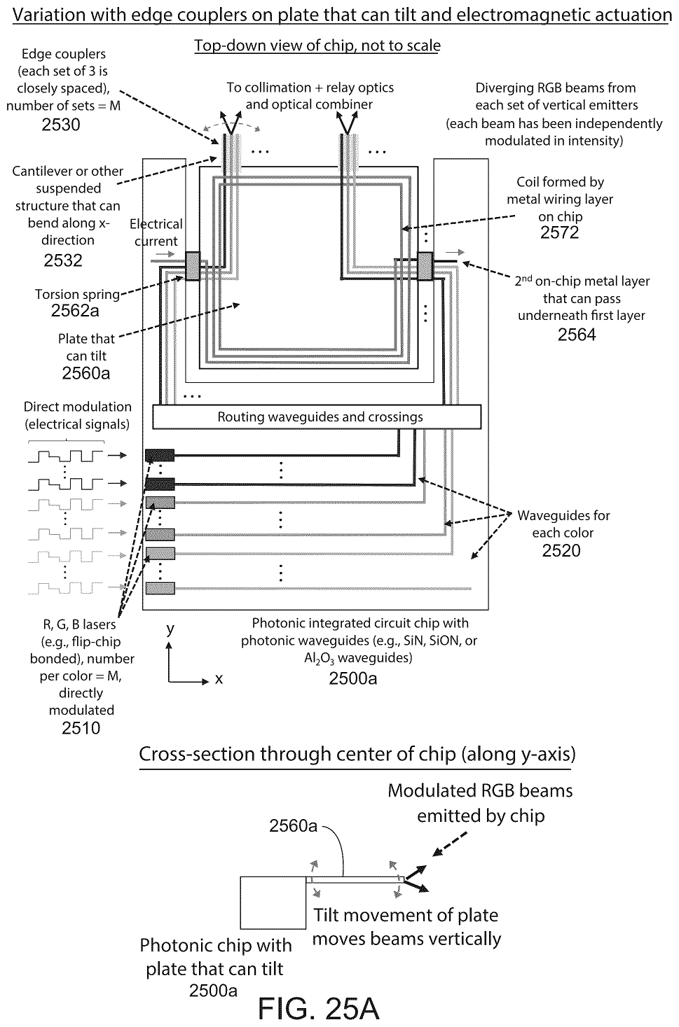

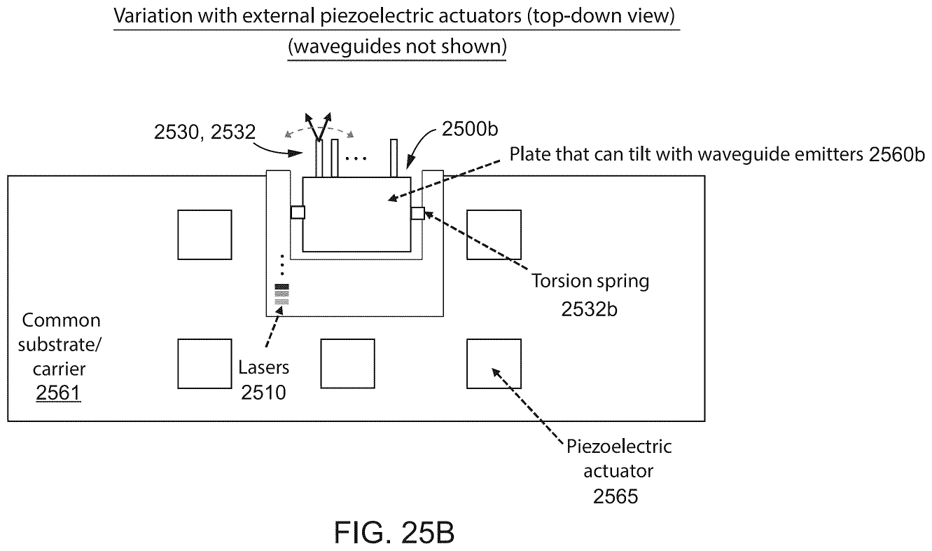

FIGS. 25A and 25B show photonic chips 2500a, 2500b with tilt plates 2560a, 2560b that support cantilevered edge couplers/waveguide emitters 2530 on cantilevers 2532 like those described above. Torsion springs 2562a, 2562b secure the tilt plates 2560a, 2560b to the respective photonic chips 2500a, 2500b and define axes of rotation about which the tilt plates 2560a, 2560b can tilt. The torsion springs 2562a, 2562b also serve as conduits for electrical signals and as conduits for waveguides 2520 that guide light from integrated lasers 2510 to the edge couplers 2530. If the edge couplers 2530 are relatively far from the torsion springs 2562a, 2562b (rotation axis) that connect the tilt plates 2560a, 2560b to the photonic chips 2500a, 2500b, a large vertical displacement may be achieved with only a small angular displacement (tilt).

The photonic chip 2500a in FIG. 25A includes a coil 2572 that is formed in a first metal layer and runs around the circumference of the movable plate 2560a. The coil 2572 is essentially a spiral made of the on-chip wiring. A second metal layer 2564 above or below the first metal layer allows electrical connection to the inside of the coil 2572 through a via. In other words, the second metal layer allows the wire to escape from the spiral.

Running a current through the coil 2572 generates a magnetic field that may be used for electromagnetically actuating the tilt plate 2560a, with quasi-static tilt of the tilt plate 2560a with applied electrical current and resonant motion of suspended structures (e.g., cantilevers 2532) at the edge of the tilt plate 2560a (if a frequency component of the electrical signal applied to the coil 2572 aligns to the mechanical resonance frequency of the cantilevers 2532). The resonant actuation may be used to achieve a second axis of motion of the waveguide emitters 2530. In FIG. 25B, external piezoelectric actuators 2565 on a common substrate/carrier 2561 with the photonic chip 2500b may be used to excite a rotational mechanical resonance of the tilt plate 2560b and mechanical resonances of the suspended structures (edge couplers 2530) at the edge of the tilt plate 2560b.

### External Actuators for Photonic Integrated Circuit Chips

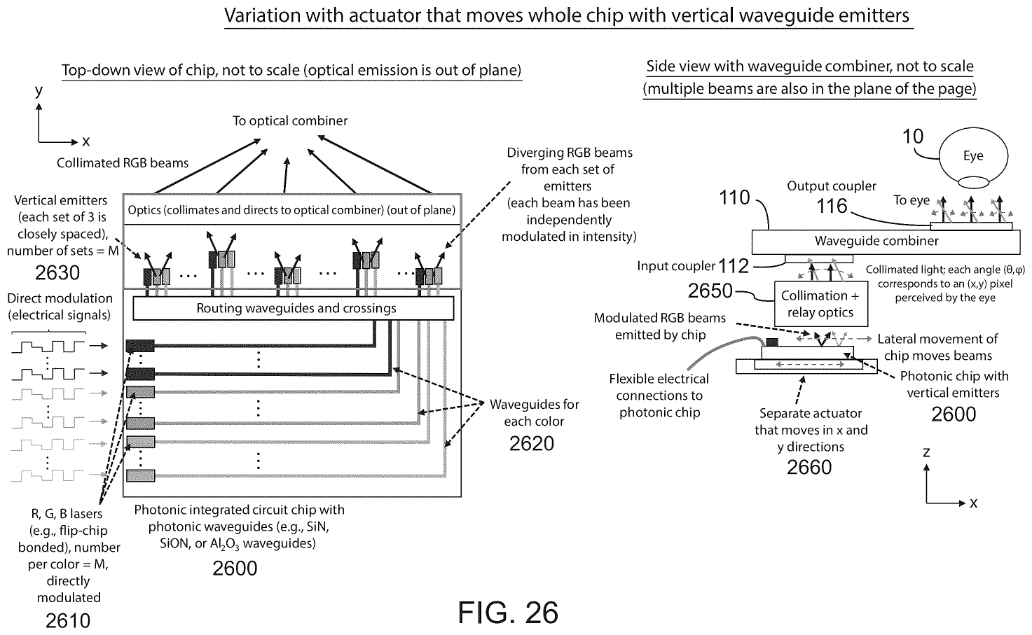

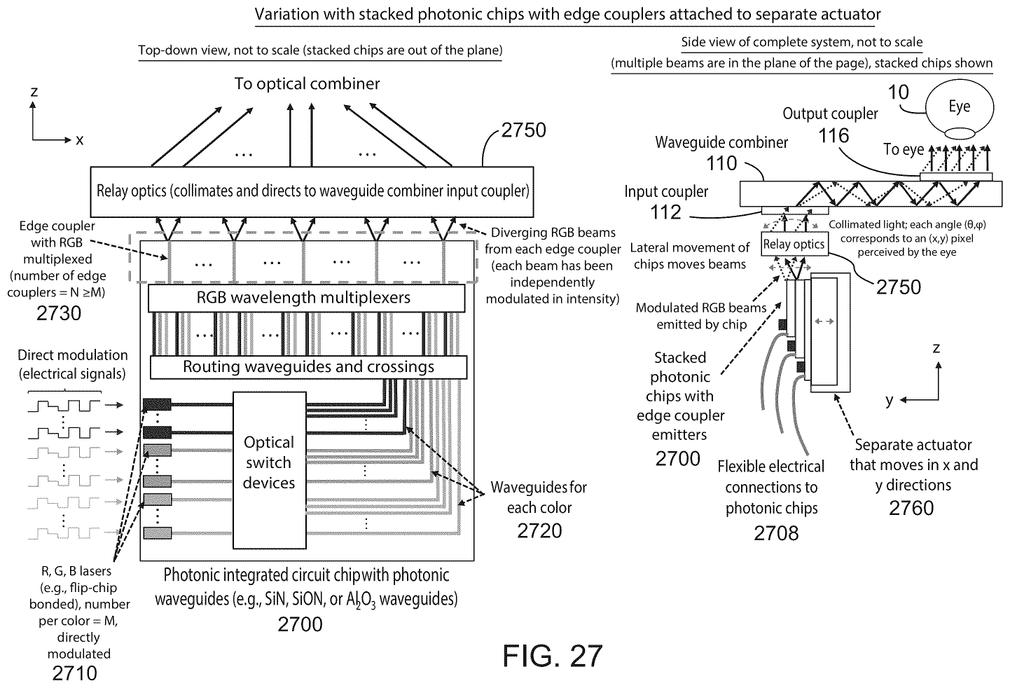

FIGS. 26 and 27 show displays in which the whole photonic integrated circuit chip 2600, 2700 (or stack of photonic chips) is attached to a separate actuator 2660, 2760 (e.g., a MEMS chip) that translates the photonic chip 2600, 2700 (with waveguide emitters) along one or more axes. Flexible electrical connections are used for this approach (e.g., flexible wire bonds or the photonic chip on a flexible PCB substrate which can bend during the movement of the actuator and photonic chip(s)).

FIG. 26 shows a photonic integrated circuit chip 2600 example with vertical waveguide emitters 2630 coupled to lasers 2610 via waveguides 2620. The entire photonic chip 2600 is mounted on a two-axis stage or actuator 2660 that moves the photonic chip 2600 in x and y dimensions (i.e., laterally in the plane of the photonic chip 2600). This lateral movement scans the vertical waveguide emitters 2630 and the beams that they emit laterally as well. Relay optics 2650 collimate the scanning beams and couple them into a waveguide combiner 110 for display to the eye 10.

FIG. 27 shows a set of stacked photonic integrated circuit chips 2700, each with edge coupler emitters 2730. The edge coupler emitters 2730 are coupled to lasers 2710 via waveguides 2720 and integrated optical switches 2714. The stacked photonic chips 2700 are mounted on a two-axis stage or actuator 2760 that moves the photonic chip 2700 in x and y dimensions (in this case, orthogonal to the planes of the stacked photonic chips 2700). This movement scans the edge coupler emitters 2730 and the beams that they emit as well. Relay optics 2750 collimate the scanning beams and couple them into a waveguide combiner 110 for display to the eye 10.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A head-mounted display comprising:
a photonic integrated circuit chip;
lasers coupled to the photonic integrated circuit chip and configured to emit beams of light;
optical waveguides formed in the photonic integrated circuit chip in optical communication with the lasers and configured to guide the beams of light;
output couplers formed in the photonic integrated circuit chip in optical communication with the optical waveguides and configured to emit the beams of light into free space; and
an actuator configured to move the output couplers in a first direction so as to scan the beams of light across respective slices of a field of view of the head-mounted display.

2. The head-mounted display of claim 1, wherein the actuator is a first actuator, and further comprising:
a second actuator configured to move the output couplers in a second direction different than the first direction so as to scan the beams of light across the field of view.

3. The head-mounted display of claim 1, wherein the lasers emit the beams of light at red, green, and blue wavelengths.

4. The head-mounted display of claim 1, wherein the lasers are configured to emit the beams of light as amplitude-modulated beams of light in response to electrical modulation.

5. The head-mounted display of claim 1, wherein the output couplers are arranged in subsets configured to emit respective groups of red, green, and blue beams of light.

6. The head-mounted display of claim 1, wherein the output couplers comprise edge couplers extending from a facet of the photonic integrated circuit chip.

7. The head-mounted display of claim 6, wherein the facet is a curved facet.

8. The head-mounted display of claim 6, wherein each of the edge couplers comprises:
a dielectric cantilever extending from the facet of the photonic integrated circuit chip;
a waveguide core formed in the dielectric cantilever; and
a metal layer disposed on at least one side of the dielectric cantilever.

9. The head-mounted display of claim 8, wherein the actuator comprises an electrode configured to apply an electrostatic force to the metal layer.

10. The head-mounted display of claim 8, wherein the actuator comprises a heater configured to heat the metal layer.

11. The head-mounted display of claim 1, wherein the output couplers comprise vertical grating couplers configured to emit the beams of light into free space.

12. The head-mounted display of claim 1, wherein the actuator is configured to move the output couplers in the first direction over a distance equal to or greater than a pitch of the output couplers in the first direction.

13. The head-mounted display of claim 1, wherein the photonic integrated circuit chip comprises multiplexers optically coupled to the optical waveguides and configured to multiplex the beams of light onto the output couplers.

14. The head-mounted display of claim 1, wherein the photonic integrated circuit chip comprises switches optically coupled to the optical waveguides and configured to route the beams of light among the optical waveguides.

15. The head-mounted display of claim 1, wherein the output couplers are disposed on a movable and/or tiltable plate suspended from a substrate of the photonic integrated circuit chip and the actuator is configured to move the movable and/or tiltable plate.

16. The head-mounted display of claim 15, wherein the movable and/or tiltable plate is suspended from the substrate of the photonic integrated circuit chip via an inner frame movable with respect to the substrate of the photonic integrated circuit chip.

17. The head-mounted display of claim 1, further comprising:
relay optics in optical communication with the output couplers and configured to collimate the light emitted by the output couplers; and
an optical combiner optically coupled to the relay optics and configured to guide the light emitted by the output couplers to an eye of a person wearing the head-mounted display.

18. The head-mounted display of claim 17, further comprising:
another actuator configured to vary a distance between the output couplers and the relay optics.

19. The head-mounted display of claim 17, further comprising:
a scanning mirror in optical communication with the relay optics and the optical combiner and configured to scan the light emitted by the output couplers.

20. The head-mounted display of claim 1, wherein the photonic integrated circuit chip is a first photonic integrated circuit chip and further comprising:
a second photonic integrated circuit chip stacked on the first photonic integrated circuit chip.
